(19) United States
(12) Patent Application Publication
(10) Pub. No.: US 2012/0324401 A1
(43) Pub. Date: Dec. 20, 2012

(54) METHODS AND SYSTEM FOR THREE DIMENSIONAL TIME AND SPACIAL USER INTERFACE

(76) Inventor: Jeffrey Morris, St. Paul, MN (US)

(21) Appl. No.: 13/159,604

(22) Filed: Jun. 14, 2011

(51) Int. Cl. G06F 3/048

(52) U.S. Cl. 715/836

(57) ABSTRACT

A three dimensional graphical user interface module operating within a computing system in a manner to display information retrieved from a database within or operatively connected to the computing system that stores a plurality of data files. The graphical user interface is configured as a plurality of viewable surfaces, wherein at least one of the plurality of viewable surfaces is configured as a sphere, displayed three-dimensionally and includes a plurality of interface items displayed thereon. In using the three dimensional graphical user interface, the user may access a second viewable surface configured as a three-dimensional sphere through an entrance point within a first viewable surface configured as a three-dimensional sphere. The three dimensional graphical user interface allows the user to access and retrieve the data stored in the database upon selecting one of the plurality of interface items illustrated on the surface of one of the plurality of viewable surfaces.

### BACKGROUND OF THE INVENTION

I. Field of the Invention

The present invention generally relates to methods and systems relating to a user interface module configured to organize data three dimensionally for a more efficient and organized display of data from a special and time perspective.

II. Background Information

Traditional computer GUI control interface systems have been two-dimensional. They are considered two-dimensional because the visual elements of traditional GUI control interface systems lie in the xy plane, and are defined in two-dimensional coordinates that are flat and contain only planar regions (areas). One of the problems with two-dimensional GUIs is that where visual elements overlap they obscure. Another problem with two-dimensional GUIs is that a planar view makes it difficult to quantify time, physical space and relational context for objects displayed. There is a need for a GUI control interface system that allows a user to quantify data from a spatial and timing perspective, whereby space and timing context can be derived from visual review of items displayed, whereby an understanding of past, present and future items and events may all be contextually understood in relation to each other. There is a need for a three-dimensional GUI system whereby the phenomenon of obscurity and loss of relational context does not occur. In such a system visual display elements shall genuinely be three-dimensional and situated in an xyz space, defined in terms of 3D coordinates, and need not be flat and may contain spatial regions (volumes).

### SUMMARY OF THE INVENTION

Consistent with embodiments of the present invention, systems and methods are disclosed regarding a three dimensional graphical user interface module operating within a computing system that facilitates the display of information retrieved from a database that stores a plurality of data files, wherein the database is connected to and or within the computing system. The graphical user interface module is configured to operatively display a plurality of viewable surfaces, wherein at least one of the plurality of viewable surfaces is configured as a sphere and displayed three-dimensionally. Wherein the at least one of three dimensionally configured viewable surface includes a plurality of interface items displayed thereon. In using the three dimensional graphical user interface module, the user may access a plurality of second level viewable surfaces configured each configured as a three-dimensional sphere through an entrance point within a first viewable surface configured as a three-dimensional sphere. The three dimensional graphical user interface module allows the user to access and retrieve the data stored in the database upon selecting one of the plurality of interface items illustrated on the surface of one of the plurality of viewable surfaces. In addition, the three dimensional graphical user interface module is also configured to facilitate a seamless content/information update by integrating with other applications that control functions including but not limited to those related to content capturing, personal information management and communication management. The three dimensional graphical user interface module also serves as a flexible and internet-accessible device and web-browser that integrates and updates content stored in the database.

It is to be understood that both the foregoing summary of the invention and the following detailed description are exemplary and explanatory only, and should not be considered restrictive of the scope of the invention, as described and claimed. Further, features and/or variations may be provided in addition to those set forth herein

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a system diagram of the computing environment within which embodiments of the present invention may be implemented;

FIG. 2 is a diagram depicting a primary viewable surface configured as a three-dimensional sphere, including a plurality of viewable surfaces configured as a three-dimensional spheres within the interior of the primary viewable surface in accordance with one embodiment of the present invention;

FIG. 3 is a diagram depicting a plurality of viewable surfaces configured as a three-dimensional sphere within the interior of a primary viewable surface such as that disclosed in FIG. 2 in accordance with one embodiment of the present invention;

FIG. 4 is a diagram depicting a plurality of viewable surfaces configured as a three-dimensional sphere within the interior of one of the three dimensional viewable surfaces within FIG. 3 in accordance with one embodiment of the present invention;

FIG. 5 is an interior view of a viewable surfaces configured as a three-dimensional sphere illustrating three-dimensional spheres representative of specific years in accordance with one embodiment of the present invention;

FIG. 6 is a diagram depicting a plurality of viewable surfaces configured as a three-dimensional spheres within the interior of each of the three dimensional viewable surfaces of FIG. 4 in accordance with one embodiment of the present invention;

FIG. 7 is a zoomed in interior view of a three-dimensional sphere representative of the year 1996 illustrated in FIG. 4 in accordance with one embodiment of the present invention;

FIG. 8 is a zoomed in interior view of a three-dimensional sphere representative of the year 1997, illustrated in FIG. 4 in accordance with one embodiment of the present invention;

FIG. 9 is zoomed in interior view of a three-dimensional sphere representative of the year 1996, illustrated in FIG. 4 in accordance with one embodiment of the present invention;

FIG. 10 is an interior view of a Monthsphere representative of the month of May, 1996 in accordance with one embodiment of the present invention;

FIG. 11 is an interior view of one of the plurality of viewable surfaces configured as a weekly three-dimensional sphere in accordance with one embodiment of the present invention;

FIG. 12 is an interior view of one of the plurality of viewable surfaces configured as a weekly three-dimensional sphere in accordance with one embodiment of the present invention;

FIG. 13 is an interior view of one of the plurality of viewable surfaces configured as a daily three-dimensional sphere in accordance with one embodiment of the present invention;

FIG. 14 is an interior view of one of the plurality of viewable surfaces configured as a daily three-dimensional sphere, illustrating the drop down scheduling menu, in accordance with one embodiment of the present invention;

FIG. 15 is an interior view of one of the plurality of viewable surfaces configured as a daily three-dimensional sphere, illustrating the drop down scheduling menu, in accordance with one embodiment of the present invention;

FIG. 16 is a diagram depicting a primary viewable surface configured as a three-dimensional sphere, including a plurality of viewable surfaces configured as a three-dimensional spheres within the interior of the primary viewable surface in accordance with an alternative embodiment of the present invention;

FIG. 17 is an interior view of one of the plurality of viewable surfaces configured as a century view of a three-dimensional sphere depicting the spatial time of events grouped by decades in accordance with one embodiment of the present invention;

FIG. 18 is a more zoomed in interior view of FIG. 17 which depicts one of the plurality of viewable surfaces configured as a century view of a three-dimensional sphere depicting the spatial time of events grouped by decades in accordance with one embodiment of the present invention;

FIG. 19 is an interior view of one of the plurality of viewable surfaces configured as a decade view of a three-dimensional sphere depicting the spatial time of events grouped by years in accordance with one embodiment of the present invention;

FIG. 20 is a zoomed in interior view of one of the plurality of FIG. 19 illustrating viewable surfaces configured as a decade view of a three-dimensional sphere depicting the spatial time of events grouped by years in accordance with one embodiment of the present invention;

FIG. 21 is a zoomed in interior view of a three-dimensional sphere representative of the year 1975, illustrated in FIGS. 19 and 20 in accordance with one alternative embodiment of the present invention;

FIG. 22 illustrates the life journal view of an embodiment of the present invention; and

FIG. 23 illustrates the fanned out display of a photo album view following entry of a photo album within the life journal display of the present invention;

FIG. 24 illustrates the specific photo following selection of a specific photo within a photo album view following entry of a photo album within the life journal display of the present invention; and

FIG. 25 illustrates the video play view following selection of a video play button within the life journal view in accordance with one embodiment of the present invention.

### GENERAL DESCRIPTION

Consistent with embodiments of the present invention, systems and methods are disclosed for a three dimensional graphical user interface module operating within a computing system that facilitates the display of information retrieved from a database that stores a plurality of data files, wherein the database is connected to and or within the computing system. The graphical user interface module comprises a plurality of viewable surfaces, wherein a primary viewable surface is configured as a three-dimensional sphere containing a plurality of variables, wherein the plurality of variables are a plurality of viewable surfaces configured to illustrate data retrieved from the database, wherein the plurality of viewable surfaces include a plurality of interface items displayed in association therewith, and in one embodiment are configured as three dimensional spheres. The three dimensional graphical user interface module may be further configured to function as a web browser that accesses data stored in associated web servers and as an interface module for applications requiring the categorization of large amounts of data in manner relative to time, such as for example a calendar, genealogy and other group reports.

The three dimensional graphical user interface module is organized in layers of viewable surfaces, wherein a user access a first layer and sub-layers visibly displayed within the first layer through an entrance portal displayed visually in a three dimensional configuration of each viewable surface. In using the three dimensional graphical user interface module, the user accesses a plurality of sub-level viewable surfaces that are each configured as a three-dimensional sphere through the entrance portal within a higher level viewable surface configured as a three-dimensional sphere. From a higher level viewable surface configured as a three dimensional sphere, a user accesses each sub-level viewable surface configured as a three-dimensional sphere. The three dimensional graphical user interface module allows the user to access and retrieve data stored in the database upon selecting one of the plurality of interface items illustrated in association with the viewable surface of one of the plurality of viewable surfaces.

For example, in one embodiment, a primary viewable surface representative of a century is configured as a hollow three-dimensional sphere and it is configured to contain within its interior ten viewable surfaces each of which are configured as hollow three-dimensional spheres that are representative of decades. In this example, the primary viewable surface configured as a hollow three dimensional sphere shall be representative of the nineteenth century, 1900, and includes ten viewable surfaces each configured as hollow three-dimensional spheres that are representative of the ten decades of the 20^{th} century, the1900s, the 1910s, the 1920s, the 1930s, the 1940s, the 1950s, the 1960s, the 1970s, the 1980s and the 1990s.

Within each viewable surface configured as a hollow three-dimensional sphere representative of a decade within the 20^{th} century are ten viewable surfaces each of which are configured as hollow three-dimensional spheres that are representative of each year of a respective decade. The first decade, the 20^{th} century, includes ten hollow three-dimensional spheres that are representative of each year of the first decade of the 20^{th} century, years 1900-1909. The second decade of the 20^{th} century, the 1910s, includes ten hollow three-dimensional spheres that are representative of each year of the second decade of the 20^{th} century, years 1910-1919. The third decade of the 20^{th} century, the 1920s, includes ten hollow three-dimensional spheres that are representative of each year of the third decade of the 20^{th} century, years 1920-1929. The fourth decade of the 20^{th} century, the 1930s, includes ten hollow three-dimensional spheres that are representative of each year of the fourth decade of the 20^{th} century, years 1930-1939. The fifth decade of the 20^{th} century, the 1940s, includes ten hollow three-dimensional spheres that are representative of each year of the fifth decade of the 20^{th} century, years 1940-1949. The sixth decade of the 20^{th} century, the 1950s, includes ten hollow three-dimensional spheres that are representative of each year of the sixth decade of the 20^{th} century, years 1950-1959. The seventh decade of the 20^{th} century, the 1960s, includes ten hollow three-dimensional spheres that are representative of each year of the seventh decade of the 20^{th} century years 1960-1969. The eighth decade of the 20^{th} century, the 1970s, includes ten hollow three-dimensional spheres that are representative of each year of the eighth decade of the 20^{th} century, years 1970-1979. The ninth decade of the 20^{th} century, the 1980s, includes ten hollow three-dimensional spheres that are representative of each year of the ninth decade of the 20^{th} century, years 1980-1989. The tenth decade of the 20^{th} century, the 1990s, includes ten hollow three-dimensional spheres that are representative of each year of the fourth decade of the 20^{th} century, years 1990-1999.

Within each hollow three-dimensional sphere that is representative of a year are twelve viewable surfaces each of may be configured as hollow three-dimensional spheres that are positioned in a linear scrollable line along a central axis of the interior of the hollow three-dimensional sphere that is representative of a year. In an embodiment in which each of the twelve viewable surfaces is representative of one of the twelve months of a given year and are configured as three-dimensional spheres, there are four or five viewable surfaces each of which may be positioned along in a linear scrollable line the central axis of a hollow three-dimensional sphere representative of one of the four or five weeks within a given month. Within each of the four or five hollow three-dimensional spheres representative of one of the four or five weeks within a given month are seven viewable day surfaces each of which may be positioned in a linear scrollable line along the central axis of a three-dimensional sphere that is representative of a week. The seven viewable day surfaces each may be configured as hollow three dimensional spheres that illustrate twenty-four viewable surfaces each representative of an hour and positioned in a linear scrollable line and including a drop down scheduler for use as a calendar.

In an alternative embodiment, the present invention can be used to categorize information related to a specific person, family, association, when the information may include documents, video, pictures or other data relative to time, wherein depending upon how organized the user would like to be, the final viewable surface may represent a display that facilitates access to information that has been organized the three-dimensional graphical user interface module. For example, electronic documents, pictures and videos of an individuals' entire life or a portion thereof may be organized using the present invention to store data in a manner relative to time. The three dimensional graphical user interface module facilitates organized and easy accessibility to the information that has been stored relative to time.

### DETAILED DESCRIPTION

The following detailed description refers to the accompanying drawings. Wherever possible, the same reference numbers are used in the drawings and the following description to refer to the same or similar parts. While several embodiments and features of the invention are described herein, modifications, adaptations and other implementations are possible, without departing from the spirit and scope of the invention. Rather these embodiments are provided so that this disclosure will be complete and will fully convey the invention to those skilled in the art. For example, substitutions, additions or modifications may be made to the components illustrated in the drawings, and the methods described herein may be modified by substituting, reordering or adding steps to the disclosed methods. Accordingly, the following detailed description does not limit the invention. Instead, the proper scope of the invention is defined by the appended claims.

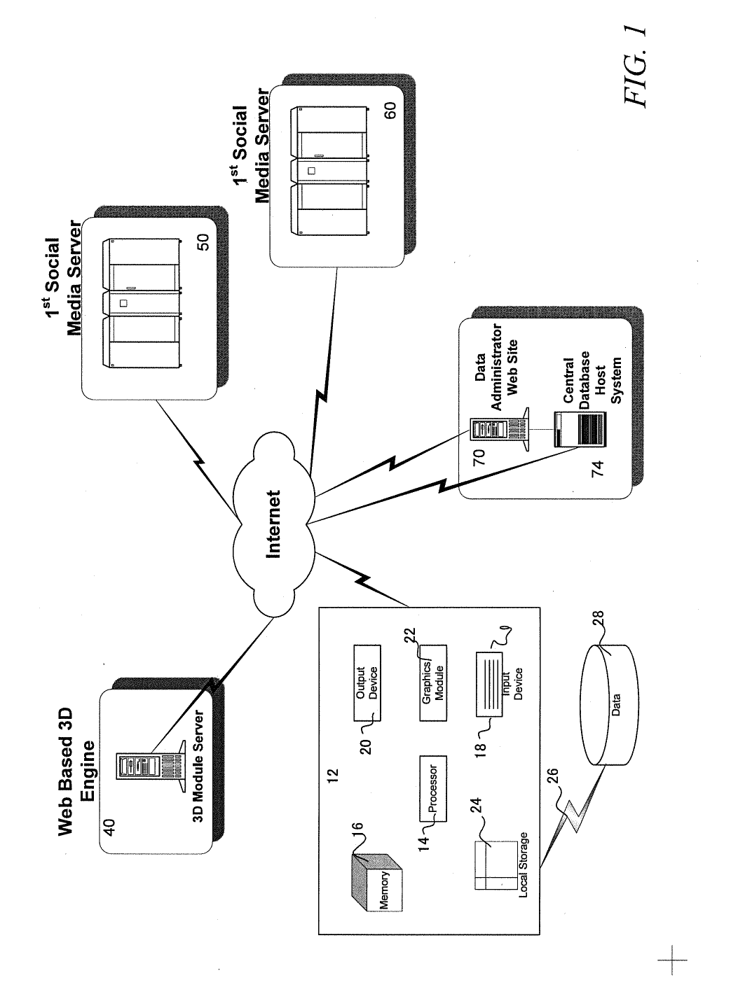

In one embodiment, the present invention is implemented as a module that runs on a personal computer, workstation, handheld computer, mobile device, consumer electronics device, or the like. One example of an implementation of the present invention is in a personal computer running the Windows XP operating system. Referring now to FIG. 1, there is shown an example of architecture for a system 10 for implementing the present invention. Personal computer 12 includes processor 14, memory 16, input devices 18 such as keyboard and mouse, and output device 20 such as a display monitor. A graphics module 22, such as a graphics card, may be provided for generating output for output device 20. A user interacts with system 10 by providing input via input devices 18 and viewing output via output device 20. Computer 12 also includes local storage 106, such as a hard drive, and can also include network connection 26 for accessing remote data 28. These components are well-known hardware components commonly used for running software applications. In one embodiment, software embodying the invention is provided on a computer-readable medium such as local storage 24. It is also contemplated that the module may be located in a cloud environment where the module is located on a web based three dimensional engine 40. In either environment the computer 12 in which the module is stored locally or accessed in a web based engine 40 accesses external servers 50, 60, 70 and data bases 74 to retrieve information to populate the three dimensional graphical user interface module.

In one embodiment, the present invention, a three dimensional graphical user interface module, is implemented as a series of hollow three-dimensional spheres organized in a manner to illustrate the association of a plurality of viewable surfaces displayable within the series of hollow three-dimensional spheres and organized relative to other viewable surfaces in the context of time. It is contemplated that the three dimensional graphical user interface module may be used in a plurality of embodiments in which there is an association of time and a plurality of display surfaces that include information, such as in the display of a calendar or genealogy report, and the display of information about a topic, person (life journal that includes pictures, documents and other electronic information) or family.

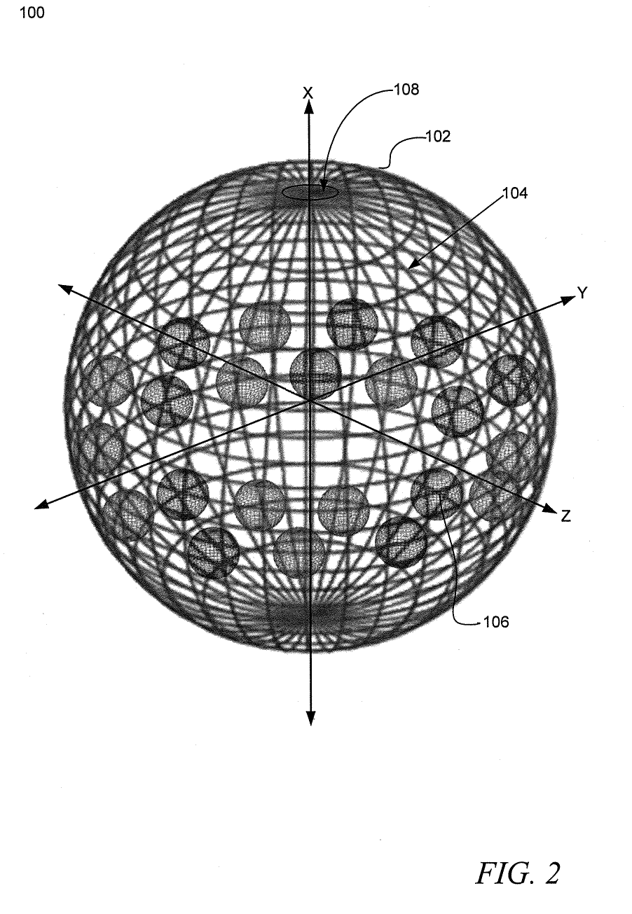

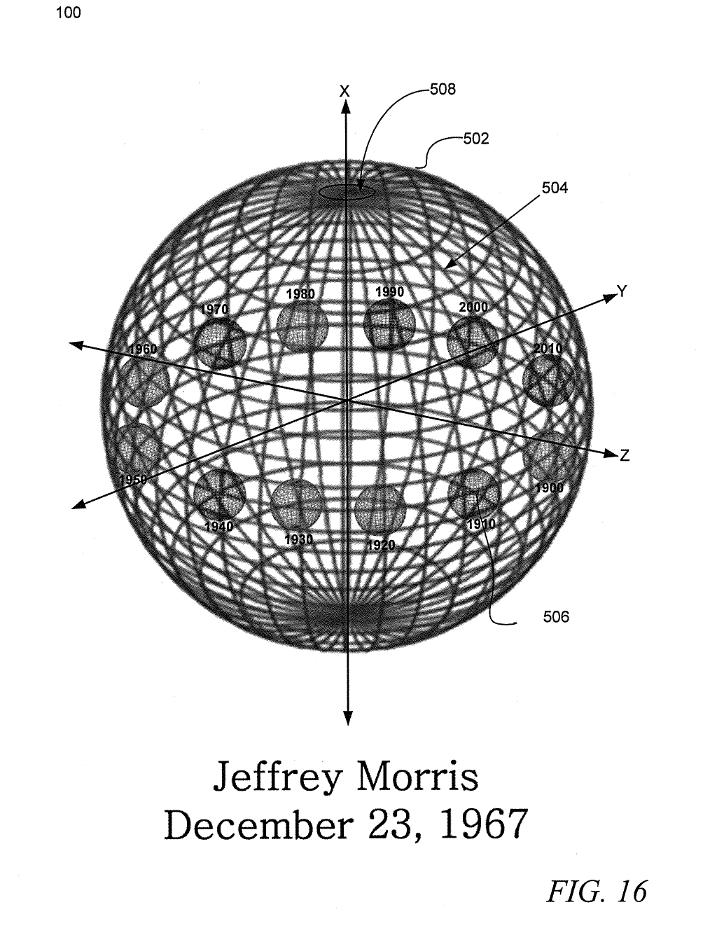

In one embodiment, illustrated in FIGS. 2-15, a calendar that utilizes the three dimensional graphical user interface module is displayed. In a second embodiment, illustrated in FIG. 16-25, a Journal that utilizes the three dimensional graphical user interface module is displayed.

FIG. 2 displays an entrance to a calendar through a first layer viewable surface 102 configured as a hollow three-dimensional sphere that includes within its interior 104 a plurality of second layer viewable surfaces 106 each configured as a hollow three-dimensional sphere. The interior 104 of the first layer viewable surface 102 is accessible through an entrance portal 108 within the first layer viewable surface 102. Generally, each viewable surface configured as a three dimensional surface, such as first layer viewable surface 102, is representative of a period of time, such as a, for example, a millennium, century, decade, year, month, week or day. In the embodiment shown in FIG. 2, viewable surface 102, a centesphere, is representative of a century and includes ten sub-level viewable surfaces 106 each configured as a hollow three-dimensional sphere and representing one of the ten decades within the respective century to which it is associated.

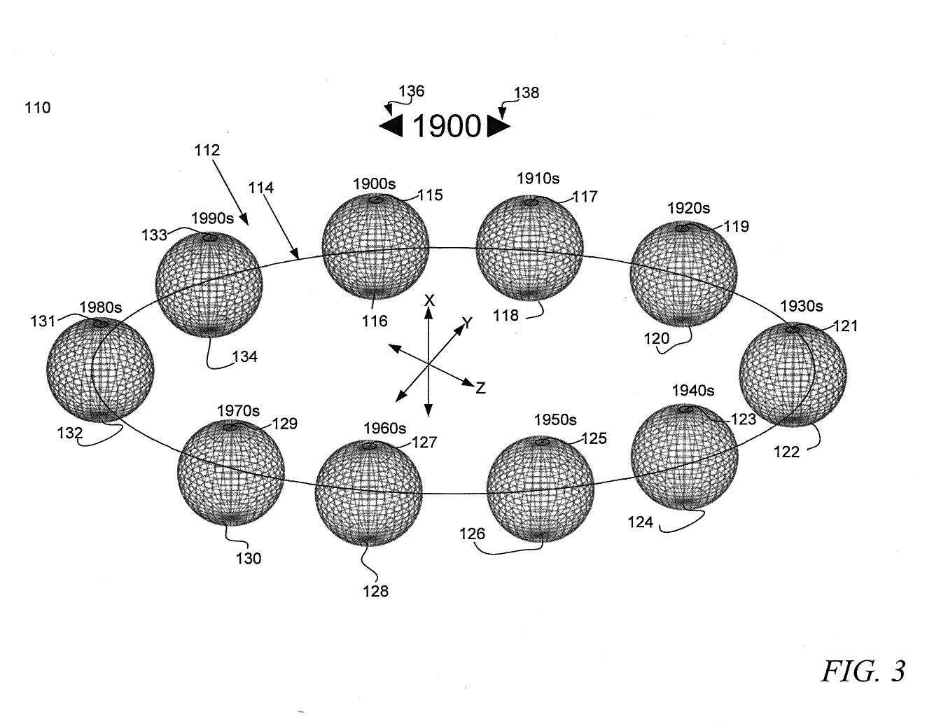

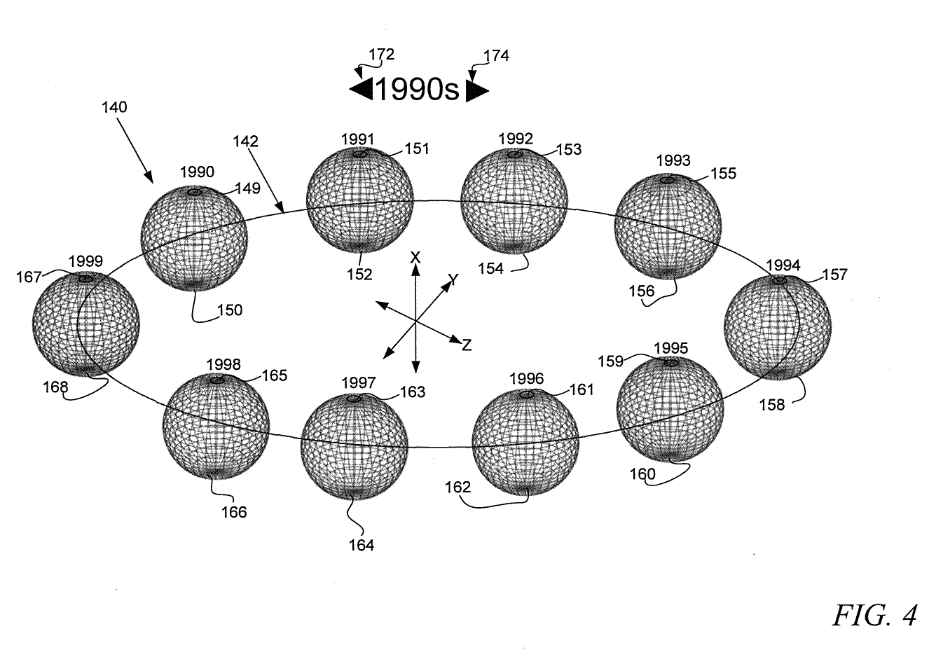

FIG. 3 is representative of the interior 112 of a Centasphere, such as the interior of Centasphere 102, shown in FIG. 2, which, for illustration purposes is representative of the 20^{th} century, the 1900s. As shown in FIG. 3, centasphere 110 includes ten sublevel viewable surfaces configured as hollow three-dimensional spheres, each positioned in a linear scrollable line along a central axis of the interior of centasphere 110. Each of the ten sub-level viewable surfaces represents one of the ten decades in the 20^{th} century, Decaspheres. Decasphere 116, representative of the first decade within the 20^{th} century, the 1900s, is configured as a three-dimensional sphere positioned along central axis 114 within the interior 112 of Centasphere 110. Access to the interior of Decasphere 116 occurs by entering through an entry portal 115, which causes the display of a point of view from within the interior of Decasphere 116. Decesphere 118, representative of the second decade within the 20^{th} century, the 1910s, is configured as a three-dimensional sphere positioned along central axis 114 within the interior 112 of Centasphere 110 and between Decasphere 116 and Decasphere 120. Access to the interior of Decasphere 118 occurs by entering through an entry portal 117, which causes the display of a point of view from within the interior of Decasphere 118. Decesphere 120, representative of the third decade within the 20^{th} century, the 1920s, is configured as a three-dimensional sphere positioned along central axis 114 within the interior 112 of Centasphere 110 and between Decasphere 118 and Decasphere 122. Access to the interior of Decasphere 120 occurs by entering through an entry portal 119, which causes the display of a point of view from within the interior of Decasphere 120. Decesphere 122, representative of the fourth decade within the 20^{th} century, the 1930s, is configured as a three-dimensional sphere positioned along central axis 114 within the interior 112 of Centasphere 110 and between Decasphere 120 and Decasphere 124. Access to the interior of Decasphere 122 occurs by entering through an entry portal 121, which causes the display of a point of view from within the interior of Decasphere 122. Decesphere 124, representative of the fifth decade within the 20^{th} century, the 1940s, is configured as a three-dimensional sphere positioned along central axis 114 within the interior 112 of Centasphere 110 and between Decasphere 122 and Decasphere 126. Access to the interior of Decasphere 124 occurs by entering through an entry portal 123, which causes the display of a point of view from within the interior of Decasphere 124. Decesphere 126, representative of the sixth decade within the 20^{th} century, the 1950s, is configured as a three-dimensional sphere positioned along central axis 114 within the interior 112 of Centasphere 110 and between Decasphere 124 and Decasphere 128. Access to the interior of Decasphere 126 occurs by entering through an entry portal 125, which causes the display of a point of view from within the interior of Decasphere 126. Decesphere 128, representative of the seventh decade within the 20^{th} century, the 1960s, is configured as a three-dimensional sphere positioned along central axis 114 within the interior 112 of Centasphere 110 and between Decasphere 126 and Decasphere 130. Access to the interior of Decasphere 128 occurs by entering through an entry portal 127, which causes the display of a point of view from within the interior of Decasphere 128. Decesphere 130, representative of the eighth decade within the 20^{th} century, the 1970s, is configured as a three-dimensional sphere positioned along central axis 114 within the interior 112 of Centasphere 110 and between Decasphere 128 and Decasphere 132. Access to the interior of Decasphere 130 occurs by entering through an entry portal 129, which causes the display of a point of view from within the interior of Decasphere 130. Decesphere 132, representative of the ninth decade within the 20^{th} century, the 1980s, is configured as a three-dimensional sphere positioned along central axis 114 within the interior 112 of Centasphere 110 and between Decasphere 130 and Decasphere 134. Access to the interior of Decasphere 132 occurs by entering through an entry portal 131, which causes the display of a point of view from within the interior of Decasphere 132. Decesphere 134, representative of the tenth decade within the 20^{th} century, the 1990s, is configured as a three-dimensional sphere positioned along central axis 114 within the interior 112 of Centasphere 110 and between Decasphere 132 and Decasphere 116. Access to the interior of Decasphere 134 occurs by entering through an entry portal 133, which causes the display of a point of view from within the interior of Decasphere 134, illustrated in FIG. 4.

The interior of Centasphere 110, illustrated in FIG. 3, is an interactive spherical display that displays each viewable exterior surface of each Decasphere within the interior 112 of Centasphere 110 that may be viewed from a variety of angles and perspectives as the user interface module facilitates pan, tilt and zoom function capabilities from a plurality of angles along the x, y, and z axis of Centasphere 110. The angle from which a user views the interior surface of a three-dimensional sphere may be modified in response to movement of a mouse-style control device connected to a computing system that rotates the perspective viewpoint of a user within the interior of a three-dimensional sphere. The module equips the interface within the interior of Centasphere 110 with an interface, 136, 138 that facilitates movement between centuries or Centaspheres. As illustrated in FIG. 3, the Decaspheres that comprise the 20^{th} century within Centasphere 110 are illustrated. Movement from the 20^{th} century back to the 19^{th} century, where the Decaspheres that comprise the 19^{th} century are displayed, may occur by engaging control interface button 136. Movement from the 20^{th} century forward to the 21^{st} century, where the Decaspheres that comprise the 21^{st} century are displayed, may occur by engaging control interface button 138. In addition a user is allowed to pan, tilt, zoom and scroll along the central axis within Centasphere 110 to facilitate rapid and controlled movement between the Decaspheres within Centasphere 110.

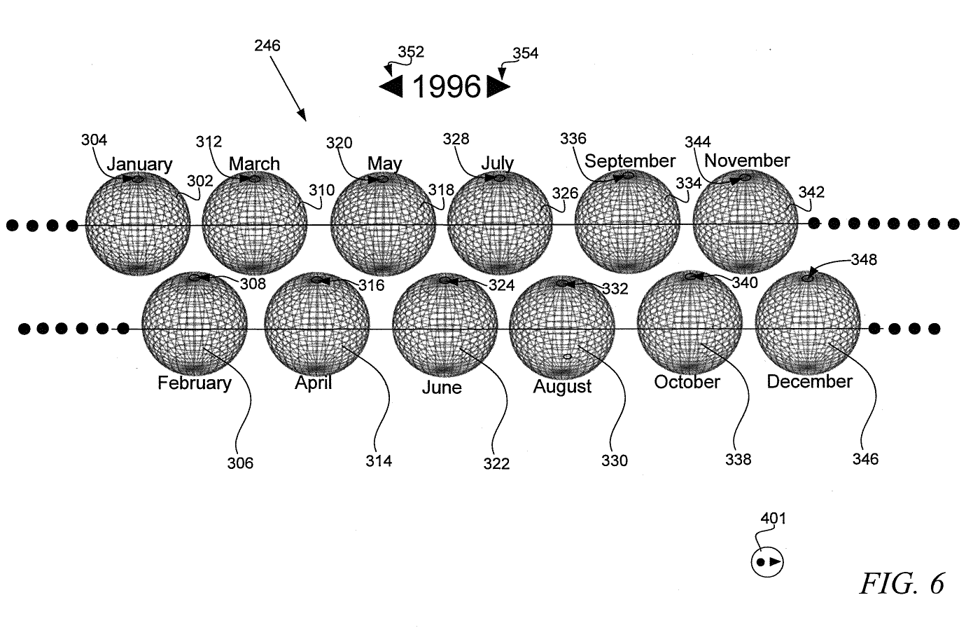

FIG. 4 illustrates the interior 140 of Decasphere 134, which may be accessed through entry portal 133. As illustrated, Decasphere 134 includes ten sub-level viewable surfaces configured as hollow three-dimensional spheres that each represents one of the ten years of the 1990s, the last decade 20^{th} century, ten Yearspheres. Yearsphere 150, representative of the year 1990, is configured as a three-dimensional sphere positioned along central axis 142 within the interior of Decasphere 134. Access to the interior of Yearsphere 150 occurs by entering through an entry portal 149, which causes the display of a point of view from within the interior of Yearsphere 150. Yearsphere 152, representative of the year 1991, is configured as a three-dimensional sphere positioned along central axis 142 within the interior of Decasphere 140. Access to the interior of Yearsphere 152, occurs by entering through an entry portal 151, which causes the display of a point of view from within the interior of Yearsphere 152. Yearsphere 154, representative of the year 1992, is configured as a three-dimensional sphere positioned along central axis 142 within the interior of Decasphere 140. Access to the interior of Yearsphere 154, occurs by entering through an entry portal 153, which causes the display of a point of view from within the interior of Yearsphere 154. Yearsphere 156, representative of the year 1993, is configured as a three-dimensional sphere positioned along central axis 142 within the interior of Decasphere 140. Access to the interior of Yearsphere 156, occurs by entering through an entry portal 155, which causes the display of a point of view from within the interior of Yearsphere 156. Yearsphere 158, representative of the year 1994, is configured as a three-dimensional sphere positioned along a central axis 142 within the interior of Decasphere 140. Access to the interior of Yearsphere 158, occurs by entering through an entry portal 157, which causes the display of a point of view from within the interior of Yearsphere 158. Yearsphere 160, representative of the year 1995, is configured as a three-dimensional sphere positioned along central axis 142 within the interior of Decasphere 140. Access to the interior of Yearsphere 160, occurs by entering through an entry portal 159, which causes the display of a point of view from within the interior of Yearsphere 160. Yearsphere 162, representative of the year 1996, is configured as a three-dimensional sphere positioned along central axis 142 within the interior of Decasphere 140. Access to the interior of Yearsphere 162, occurs by entering through an entry portal 161, which causes the display of a point of view from within the interior of Yearsphere 162, illustrated in FIG. 6. Yearsphere 164, representative of the year 1997, is configured as a three-dimensional sphere positioned along central axis 142 within the interior of Decasphere 140. Access to the interior of Yearsphere 164, occurs by entering through an entry portal 163, which causes the display of a point of view from within the interior of Yearsphere 164. Yearsphere 166, representative of the year 1998, is configured as a three-dimensional sphere positioned along central axis 142 within the interior of Decasphere 140. Access to the interior of Yearsphere 166, occurs by entering through an entry portal 165, which causes the display of a point of view from within the interior of Yearsphere 166. Yearsphere 168, representative of the year 1999, is configured as a three-dimensional sphere positioned along central axis 142 within the interior of Decasphere 140. Access to the interior of Yearsphere 168, occurs by entering through an entry portal 167, which causes the display of a point of view from within the interior of Yearsphere 166. The module equips the interface within the interior of Decasphere 140 with an interface, 172, 174 that facilitates movement between centuries or Centaspheres. As illustrated in FIG. 4, the Yearspheres that comprise the 1990s within Decasphere 140 are illustrated. Movement from the 1990s decade back to the 1980s decade, where the Yearspheres that comprise the 1980s decade are displayed, may occur by engaging control interface button 172. Movement from the 1990s decade forward to the 2000s decade, where the Decaspheres that comprise the 2000s decade are displayed, may occur by engaging control interface button 174. In addition, a user is allowed to pan, tilt, zoom and scroll along the central axis within the Decasphere 134 to facilitate rapid and controlled movement between the Yearspheres within the Decasphere 134.

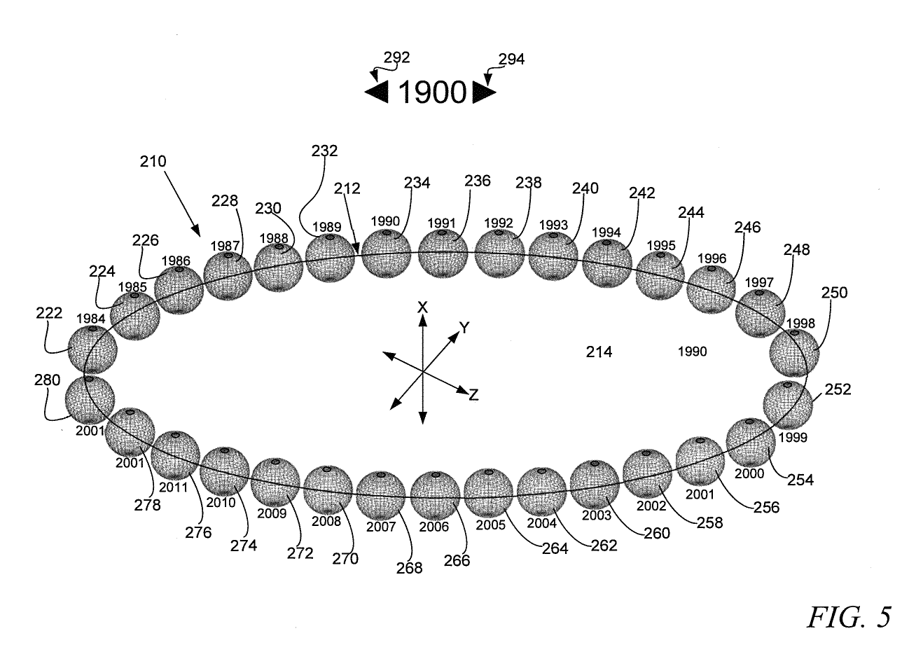

The three-dimensional graphical user interface module facilitates intuitive organization of three-dimensional calendars such as the spherical representation of a century/Centasphere 100 shown in FIG. 2 and having, as illustrated in FIG. 3, ten Decaspheres 110 positioned within the interior of the Centasphere 112, where each Decasphere shown in FIG. 3 has, as shown in FIG. 4, at least ten year spheres within the interior of a representative Decasphere 140. It is also contemplated that a Centersphere such as that represented in FIG. 2 may include more Decaspheres than the ten Decaspheres representative of a particular century, and a Decasphere such as that represented in FIG. 3 may include more Yearspheres than the ten Yearspheres representative of a particular decade. For example, FIG. 5, illustrates the interior of an interactive spherical display 210 that includes Yearspheres from the 1980s, 1990s, 2000s and 2010s. Entry into a viewable surface including the Yearspheres illustrated may be through Decasphere 134 shown in FIG. 3. However, the Yearspheres illustrated are organized through the three-dimensional graphical user interface module in a manner that displays the Yearspheres for a respective decade, for example, the 1990s, and all other respective Yearspheres proximate to the Yearspheres representative of the 1990s along a scrollable linear axis within the viewable surface wherein the beginning and ending years of the representative yearsspheres within a respective viewable surface configured as a three-dimensional sphere are set by the input of parameters into the module.

Referring to FIG. 6, FIG. 6 is representative of the interior surface 246 of Yearsphere 162, shown in FIG. 4, which may be entered through entry portal 161. As illustrated in FIG. 6, the interior surface 246 of the Yearsphere representative of the year 1996, includes twelve sub-level viewable surfaces configured as hollow three-dimensional spheres each positioned in a linear scrollable line along a central axis of the interior of Yearsphere 162. Each of the twelve sub-level viewable surfaces represents one of the twelve months years of the year, Monthspheres. Monthsphere 302, representative of the month of January, is configured as a three-dimensional sphere positioned along a central axis within the interior surface 246 of the Yearsphere representative of 1996. Access to the interior of Monthsphere 302 occurs by entering through an entry portal 304, which causes the display of a point of view from within the interior of Monthsphere 302. Monthsphere 306, representative of the month of February, is configured as a three-dimensional sphere positioned along a central axis within the interior surface 246 of the Yearsphere representative of 1996. Access to the interior of Monthsphere 306, occurs by entering through an entry portal 308, which causes the display of a point of view from within the interior of Monthsphere 306. Monthsphere 310, representative of the month of March, is configured as a three-dimensional sphere positioned along a central axis within the interior surface 246 of the Yearsphere representative of 1996. Access to the interior of Monthsphere 310, occurs by entering through an entry portal 312, which causes the display of a point of view from within the interior of Monthsphere 310. Monthsphere 314, representative of the month of April, is configured as a three-dimensional sphere positioned along a central axis within the interior surface 246 of the Yearsphere representative of 1996. Access to the interior of Monthsphere 314, occurs by entering through an entry portal 316, which causes the display of a point of view from within the interior of Monthsphere 314. Monthsphere 318, representative of the month of May, is configured as a three-dimensional sphere positioned along a central axis within the interior surface 246 of the Yearsphere representative of 1996. Access to the interior of Monthsphere 318, occurs by entering through an entry portal 320, which causes the display of a point of view from within the interior of Monthsphere 318. Monthsphere 322, representative of the month of June, is configured as a three-dimensional sphere positioned along a central axis within the interior surface 246 of the Yearsphere representative of 1996. Access to the interior of Monthsphere 322, occurs by entering through an entry portal 324, which causes the display of a point of view from within the interior of Monthsphere 322. Monthsphere 326, representative of the month of July, is configured as a three-dimensional sphere positioned along a central axis within the interior surface 246 of the Yearsphere representative of 1996. Access to the interior of Monthsphere 326, occurs by entering through an entry portal 328, which causes the display of a point of view from within the interior of Monthsphere 326. Monthsphere 330, representative of the month of August, is configured as a three-dimensional sphere positioned along a central axis within the interior surface 246 of the Yearsphere representative of 1996. Access to the interior of Monthsphere 330, occurs by entering through an entry portal 332, which causes the display of a point of view from within the interior of Monthsphere 330. Monthsphere 334, representative of the month of September, is configured as a three-dimensional sphere positioned along a central axis within the interior surface 246 of the Yearsphere representative of 1996. Access to the interior of Monthsphere 334, occurs by entering through an entry portal 336, which causes the display of a point of view from within the interior of Monthsphere 334. Monthsphere 338, representative of the month of October, is configured as a three-dimensional sphere positioned along a central axis within the interior surface 246 of the. Yearsphere representative of 1996. Access to the interior of Monthsphere 338, occurs by entering through an entry portal 340, which causes the display of a point of view from within the interior of Monthsphere 338. Monthsphere 342, representative of the month of November, is configured as a three-dimensional sphere positioned along a central axis within the interior surface 246 of the Yearsphere representative of 1996. Access to the interior of Monthsphere 342, occurs by entering through an entry portal 344, which causes the display of a point of view from within the interior of Monthsphere 342. Monthsphere 346, representative of the month of December, is configured as a three-dimensional sphere positioned along a central axis within the interior surface 246 of the Yearsphere representative of 1996. Access to the interior of Monthsphere 346, occurs by entering through an entry portal 348, which causes the display of a point of view from within the interior of Monthsphere 346.

The interior of Yearsphere 162, illustrated in FIG. 6, is an interactive spherical display that displays each viewable exterior surface of each Monthsphere within the interior 246 of Yearsphere 162 that may be viewed from a variety of angles and perspectives as the user interface module facilitates pan, tilt and zoom function capabilities from a plurality of angles along the x, y, and z axis of Yearsphere 162. The angle from which a user views the interior surface of a three-dimensional sphere may be modified in response to movement of a mouse-style control device connected to a computing system that rotates the perspective viewpoint of a user within the interior of a three-dimensional sphere. The module equips the interface within the interior 246 of Yearsphere 162 with an interface, 352, 354 that facilitates movement between years or Yearspheres. As illustrated in FIG. 6, the Monthspheres that comprise the year 1996 are illustrated. Movement from inside the Yearsphere representative of 1996 back to the Yearsphere representative of 1995, which includes the display of Monthspheres representative of the year 1995, may occur by engaging control interface button 352. Movement from inside the Yearsphere representative of 1996 forward to the Yearsphere representative of 1997, which includes the display of Monthspheres representative of the year 1997, may occur by engaging control interface button 354. In addition a user is allowed to pan, tilt, zoom and scroll along the central axis within the interior 246 of Yearsphere 162 to facilitate rapid and controlled movement between the Monthspheres within Yearsphere 162.

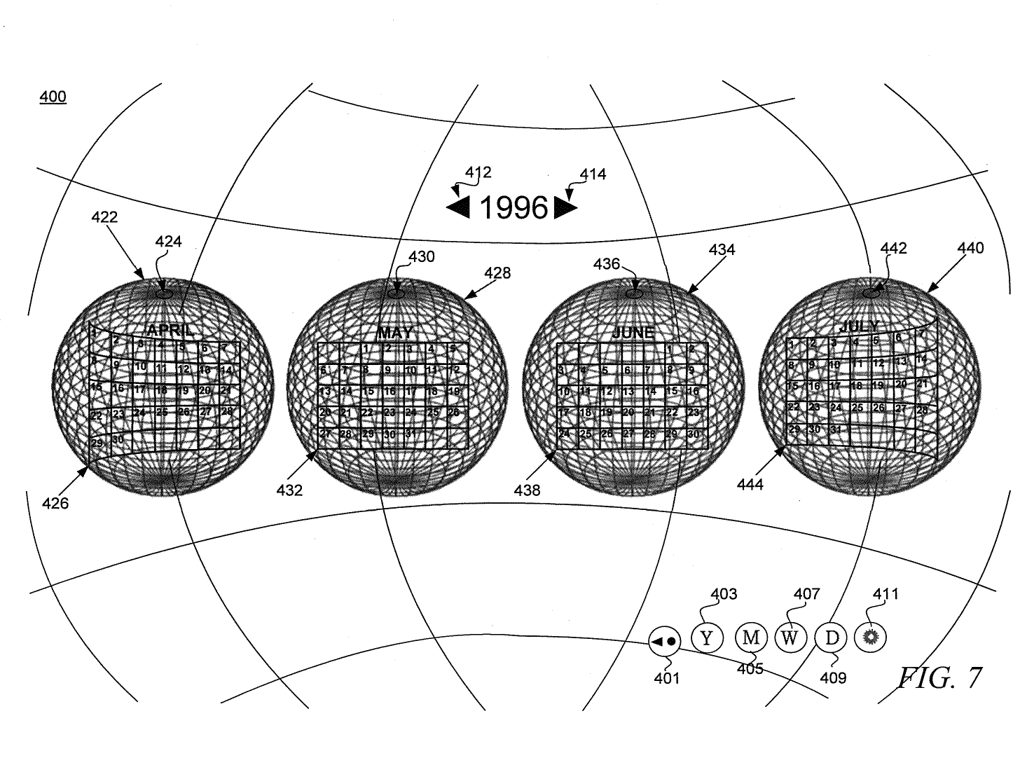

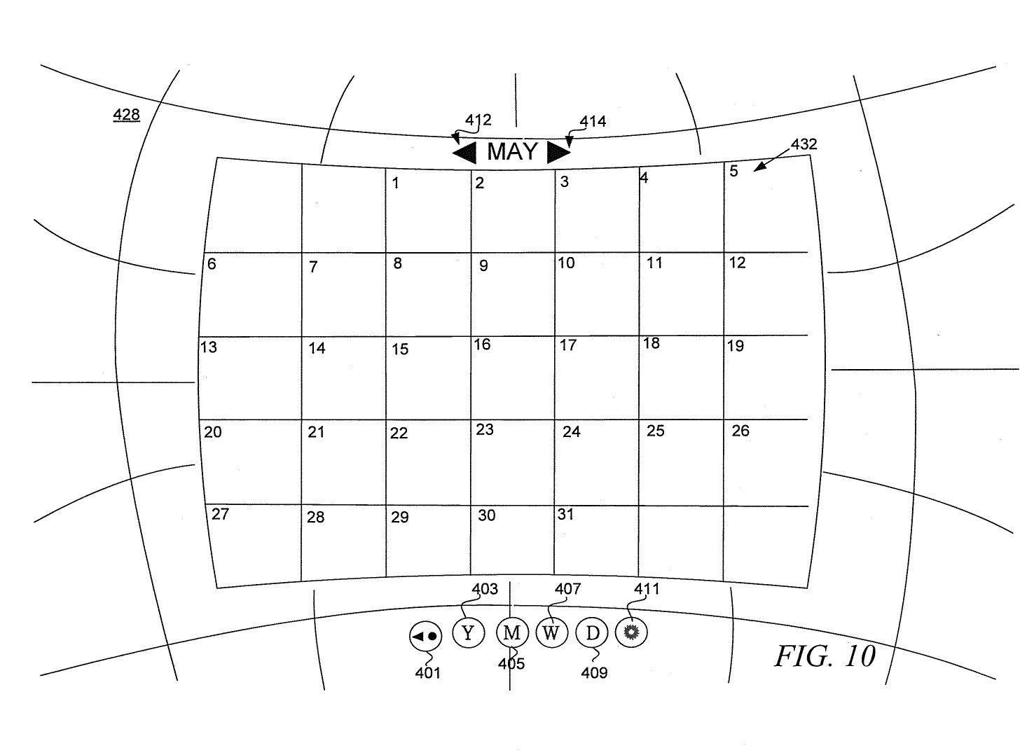

FIG. 7 is representative of the interior surface of a Yearsphere 400, representative of the year 1996, illustrating four sub-level viewable surfaces configured as hollow three-dimensional spheres, Monthspheres, that each represents the months of April, May, June and July of the year 1996. FIG. 7 is an alternative display of FIG. 6, wherein the monthshpheres illustrated in FIG. 7 are organized by the three-dimensional graphical user interface module in a manner that displays the Monthspheres for a respective year, for example, the year 1996, and all other respective Monthspheres proximate to the Monthspheres representative of the 1996 along a linear line wherein the beginning and ending of the representative months within a respective viewable surface configured as a three-dimensional sphere are set by the input of parameters into the module. FIG. 7 represents a zoomed view of the Yearsphere representative of the year 1996 zooming in on the months of April, May, June and July. Monthsphere 422, representative of the month of April, is configured as a three-dimensional sphere positioned along a central axis within the interior surface 400 of the Yearsphere representative of the year 1996. Access to the interior of Monthsphere 422, occurs by entering through an entry portal 424, which causes the display of a point of view from within the interior of Monthsphere 422 that facilitates the display of a surface 426 representative of the month of April for calendar year 1996. Monthsphere 428, representative of the month of May, shown in a zoomed view in FIG. 10, is configured as a three-dimensional sphere positioned along a central axis within the interior surface 400 of the Yearsphere representative of the year 1996. Access to the interior of Monthsphere 428, occurs by entering through an entry portal 430, which causes the display of a point of view from within the interior of Monthsphere 428 that facilitates the display of a surface 432 representative of the month of May for calendar year 1996. Similar to the month of April and May, Monthspheres 434, 440 representative of the months of June and July, display surfaces 438, and 444 representative of the respective of the months of June and July that may be accessed by entering through entry portals 436 and 442.

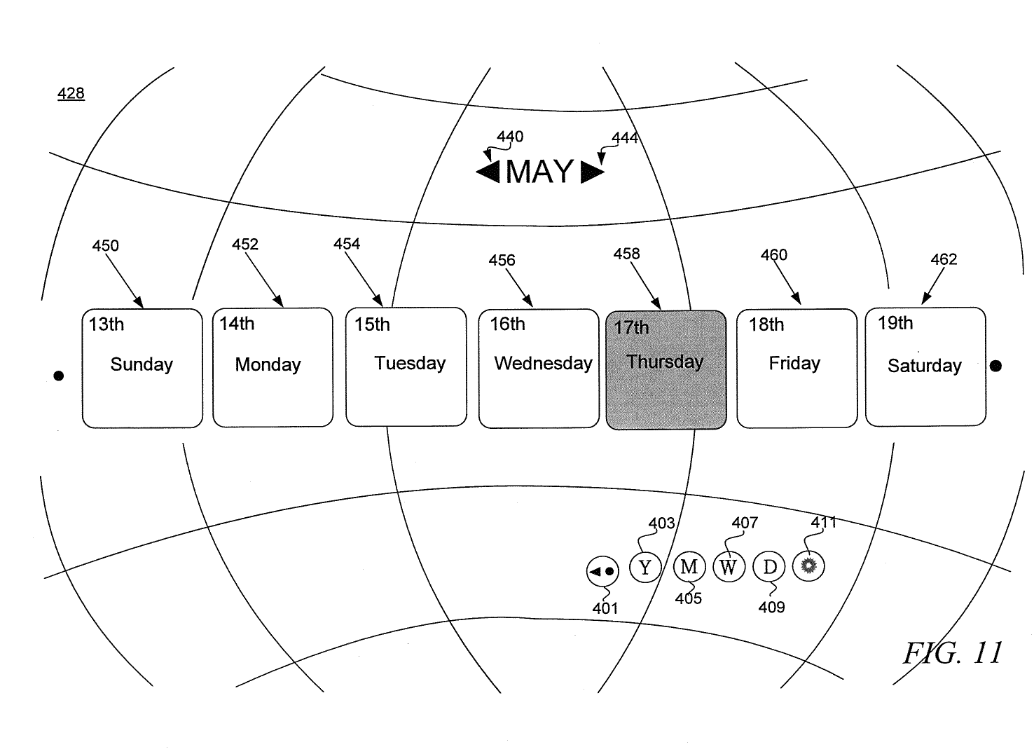

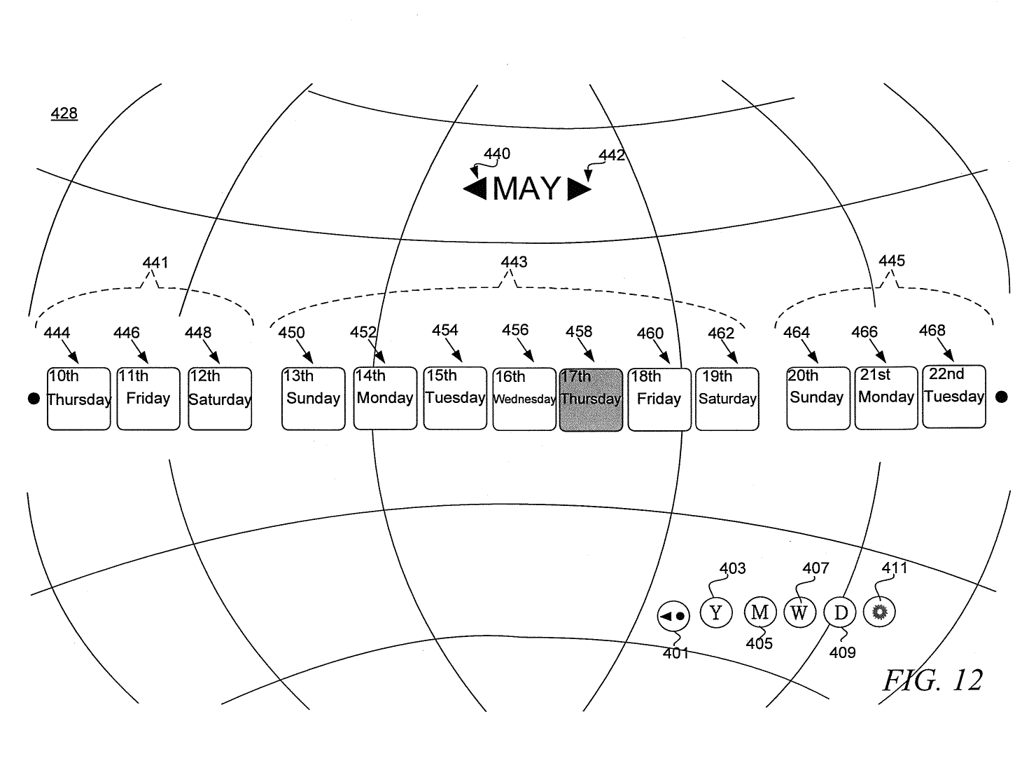

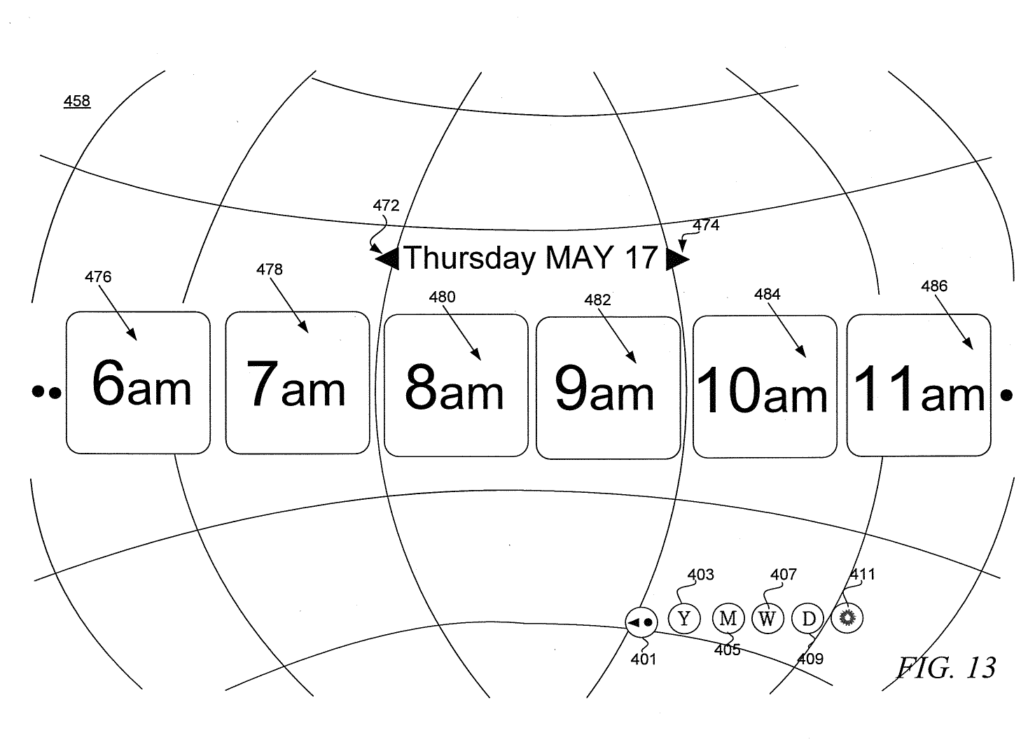

Yearsphere 400, which includes graphical representations of the Monthspheres for the year 1996, specifically Monthspheres for April 422, May 428, June 434 and July 440 includes control interface buttons, wherein a control interface expand button 401 causes the display of control buttons, 403, 405, 407, 409 and 411. Button 403 facilitates the display of the interior of a viewable surface that includes Yearspheres, such as the Yearspheres disclosed in FIG. 4. Button 405 facilitates the display of the interior of a viewable surface that includes Monthspheres, such as the Monthspheres disclosed in FIGS. 6 and 7. Button 407 facilitates the display of the interior of a viewable surface that includes Weekspheres such as the Weekspheres disclosed in FIGS. 11 and 12. Button 409 facilitates the display of the interior of a viewable surface that includes Dayspheres such as the Dayspheres disclosed in FIGS. 13, 14 and 15.

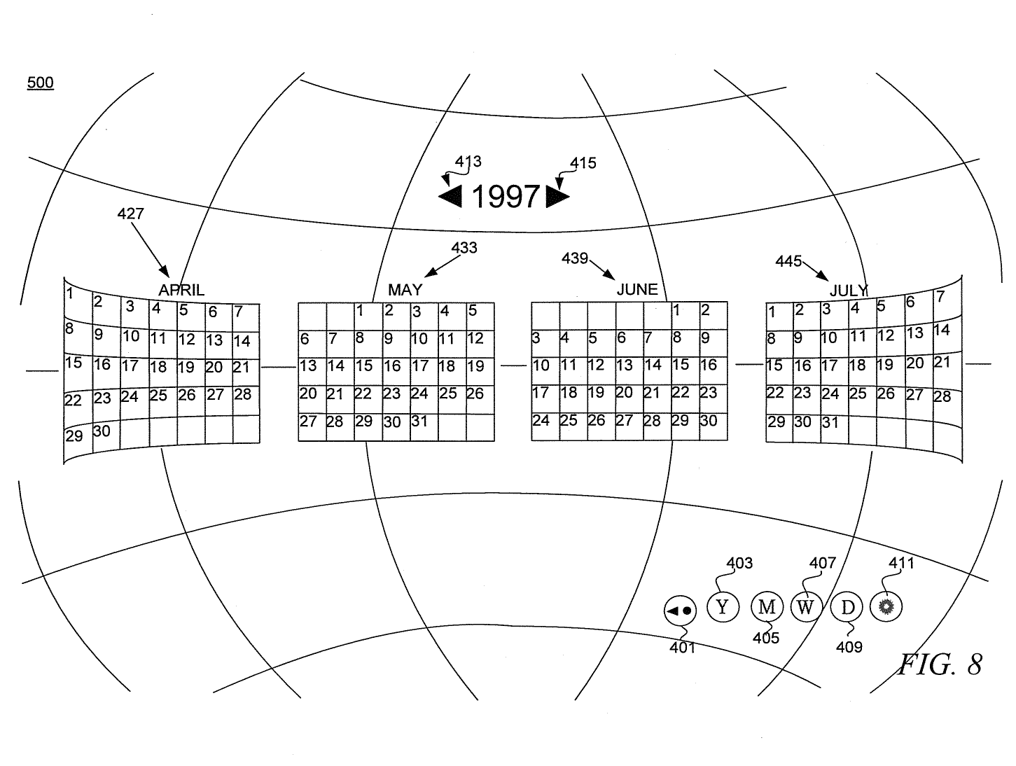

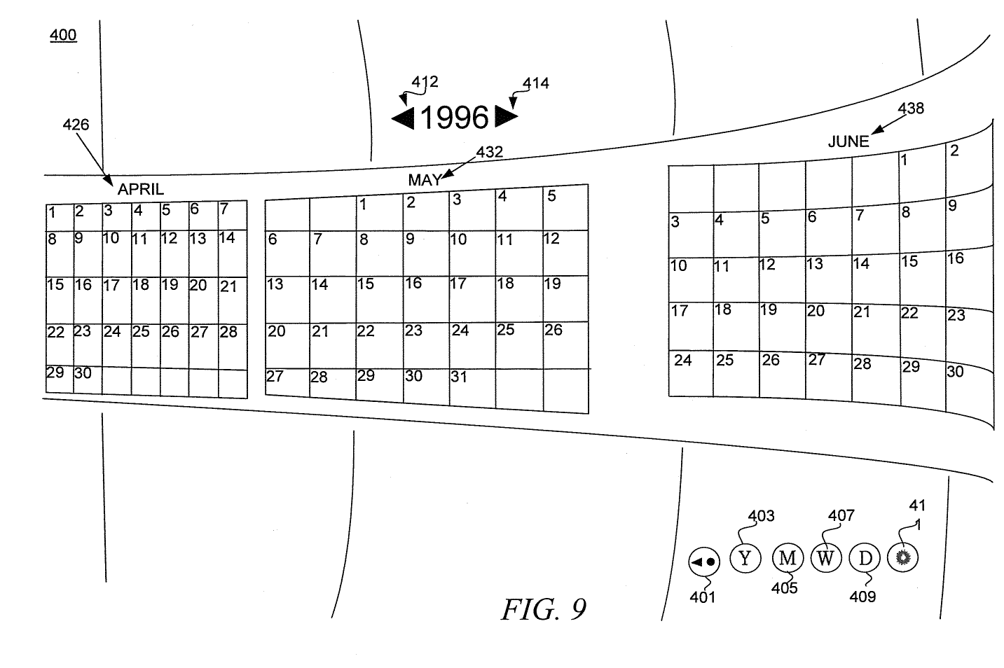

The three dimensional graphical user interface module equips the interface within the interior of Yearsphere 400 with an interface, 412, 414 that facilitates movement between years or Yearspheres. As illustrated in FIG. 7, the Monthspheres 422, 428, 434, 440 for the months April, May, June and July for the year 1996 are illustrated. Movement from the Yearsphere representative of 1996 backward to the Yearsphere representative of 1995 occurs by engaging control interface button 412. Movement from the Yearsphere representative of 1996 forward to the Yearsphere representative of 1997, illustrated in FIG. 8, which includes the display of viewable surfaces 427, 433, 439, 445 for the months April, May, June and July for the year 1997, occurs by engaging control interface button 414. As illustrated in FIGS. 8 and 9, the viewable surfaces representative of respective months, for example the months April, May, June and July may also be displayed as viewable surfaces that are not configured within a three-dimensional sphere. In both embodiments, one illustrated in FIGS. 7, showing the viewable surfaces representative of respective months being configured within three-dimensional spheres, and a second embodiment, illustrated in FIGS. 8 and 9, showing the viewable surfaces representative of respective months as not being configured within three-dimensional spheres, access to additional sub-layers of viewable surfaces, such as day views may be accessed by selecting a day within a monthly viewable surface, such as the viewable surface 432 for the month of May.

Referring to FIG. 10, Monthsphere 428, representative of the month of May in the year 1996, is illustrated. FIG. 11 is also an illustration of a hollow three-dimensional sphere configured such that a viewable surface 428, representative of the month of May in the year 1996, displays seven days of a respective week, a Weeksphere. In this example, the viewable surface is comprised of a graphical user interface representative of Sunday May 13, 1996 through Saturday, May 19, 1996. Sunday May 13^{th} is represented by display surface 450, Monday May 14^{th} is represented by display surface 452, Tuesday May 15^{th} is represented by display surface 454, Wednesday May 16^{th} is represented by display surface 456, Thursday May 17^{th} is represented by display surface 458, Friday May 18^{th} is represented by display surface 460, and Saturday May 19^{th} is represented by display surface 462. A weeksphere may be displayed in the manner illustrated in FIG. 11, wherein only one week is displayed, alternatively, a Weeksphere may be displayed as illustrated in FIG. 12, wherein the days of the week are grouped together but displayed linearly along an axis within the Monthsphere wherein the user may access any week of any respective month, year or century along a respective display line wherein the weeks displayed within a respective Weeksphere are viewed as a string of weeks, such as weeks, 441, 443, 445 that begin and end on the date defined within the module.

Upon selection of display surface 458, which is representative of Thursday May 17, 2996, the module presents a display mode representative of a Daysphere 458 wherein the twenty four hours within a day are displayed along a linear axis of viewable surface 458. It is contemplated that a user may enter the day sphere for the previous or following day upon forward or backward movement along the linear axis into another twenty-four hour grouping representative of a prior or subsequent day. The module equips the interface within the interior of a Yearsphere, such as Yearsphere 458 with an interface, 472, 474 that facilitates movement between days or Dayspheres.

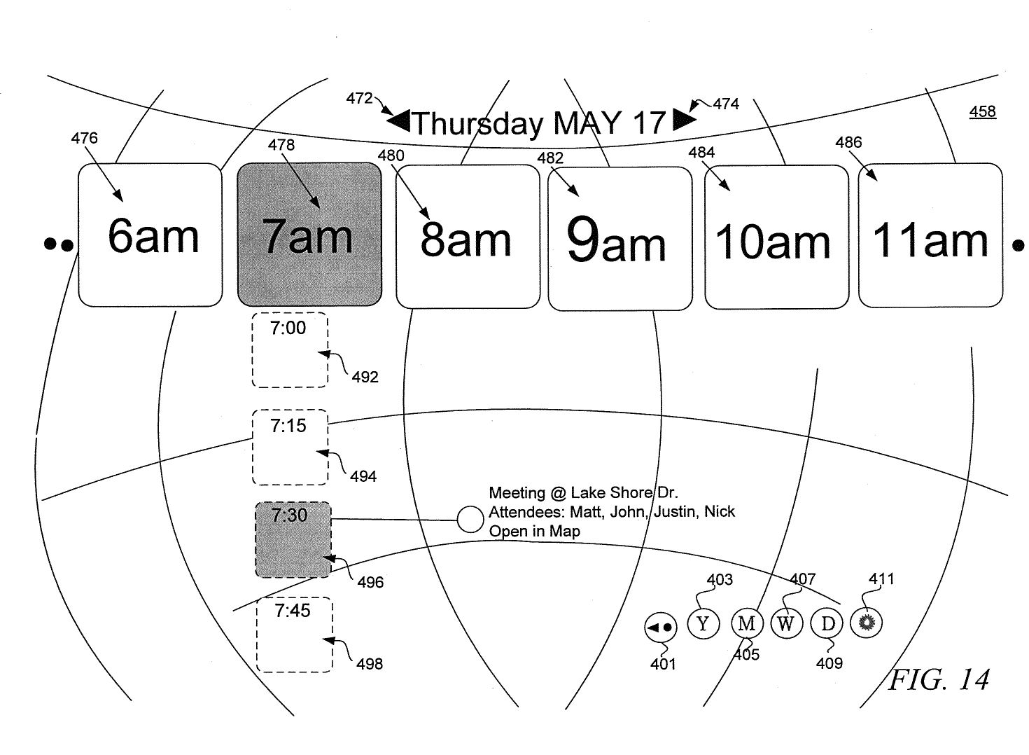

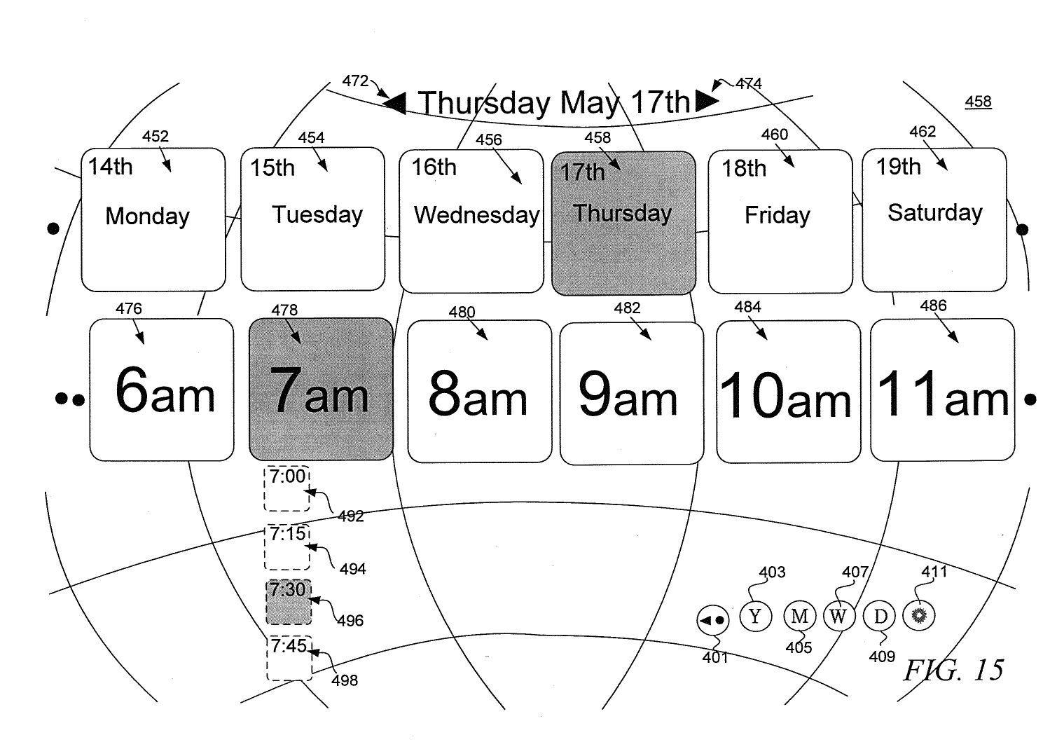

FIG. 14, illustrates the selection of a respective time display, for example, time display surface 478 which is representative of the seventh hour within the twenty-four hour period representative of the date May 17, 1996. As illustrated, upon selection of time display surface 478, time display surfaces representative of intervals of a respective hour are displayed. In the example illustrated in FIG. 14, the hour of 7AM is displayed in four fifteen minute intervals, 492, 494, 496, 498, representative of 7:00AM, 7:15AM, 7:30AM, and 7:45AM. It is also contemplated that the Weeksphere and the Daysphere may be presented in a combined display as illustrated in FIG. 15. In this embodiment, upon the selection of a specific day, such as the day display 458 representative of Thursday May 17^{th}, day display surfaces 452, 454, 456, 458, 460, 462 are displayed along a scrollable axis along with the hour display surfaces, for example 476, 478, 480, 482, 484, 486, that are displayed along a scrollable axis that is scrolled independently of the day display surfaces.

Yearspheres 400 and 500, shown in FIGS. 7-9, representative of the Monthspheres for the year 1996; Monthsphere 428 for the month of may 1996 displayed in monthly calendar mode in FIG. 10; linear Weeksphere mode in FIGS. 11 and 12; and Daysphere mode in FIGS. 14, 14 and 15, all include control interface buttons, wherein selecting control button 401 causes the display of control buttons, 403, 405, 407, 409 and 411. Button 403 facilitates the display of the interior of a viewable surface that includes Yearspheres, such as the Yearspheres disclosed in FIG. 4. Button 405 facilitates the display of the interior of a viewable surface that includes Monthspheres, such as the Monthspheres disclosed in FIGS. 6 and 7. Button 407 facilitates the display of the interior of a viewable surface that includes weekspheres such as the weekspheres disclosed in FIGS. 11 and 12. Button 409 facilitates the display of the interior of a viewable surface that includes Dayspheres such as the Dayspheres disclosed in FIGS. 13, 14 and 15.

FIG. 16, illustrates an embodiment of in which the three dimensional graphical user interface module is used in a journal module that facilitates easy access to information that has been stored and organized in an associated manner relative to time. For example, if a specific user, Jeffrey Morris, uses a three-dimensional graphical user interface module to organize images and specific information concerning events along with associated documents and video content that has occurred in his respective lifetime, resulting in the information being organized as a Life Journal™. As illustrated, FIG. 16 displays an entrance to the Life Journal™ through a first layer viewable surface 502 configured as a hollow three-dimensional sphere that includes within its interior 504 a plurality of second layer viewable surfaces 506 each configured as a hollow three-dimensional sphere. The interior 504 of the first layer viewable surface 502 is accessible through an entrance portal 508 within the first layer viewable surface 502. Generally, each viewable surface configured as a three dimensional image, such as first layer viewable surface 502, is representative of a period of time, such as a millennium, century, decade, year, month, week or day. In the embodiment shown in FIG. 2, viewable surface 502 is representative of a century, Centasphere, which includes twelve sub-level viewable surfaces 506 each of which is configured as a hollow three-dimensional sphere and represents decades, Decaspheres, beginning with the 1900s and ending with the Decade for the years within the 2010s.

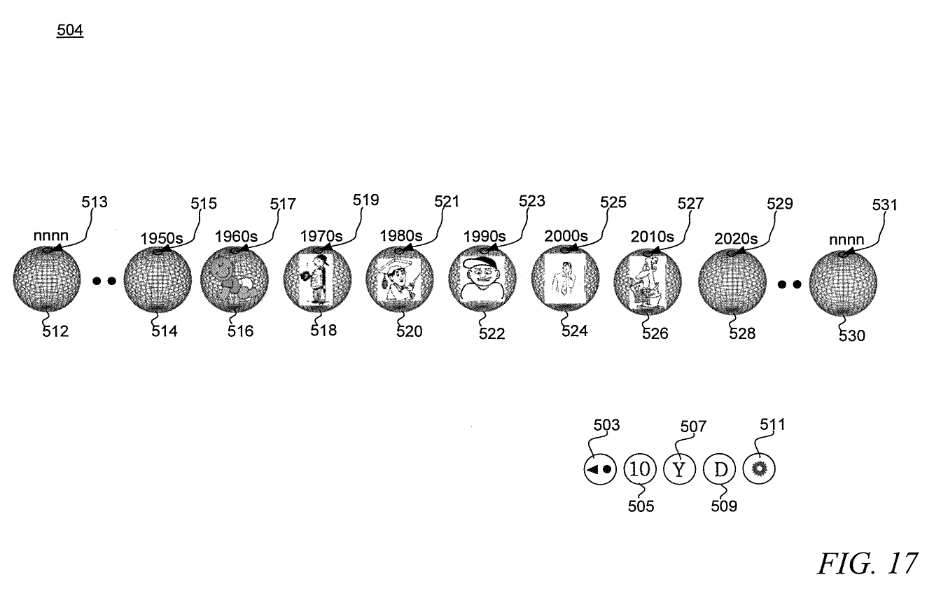

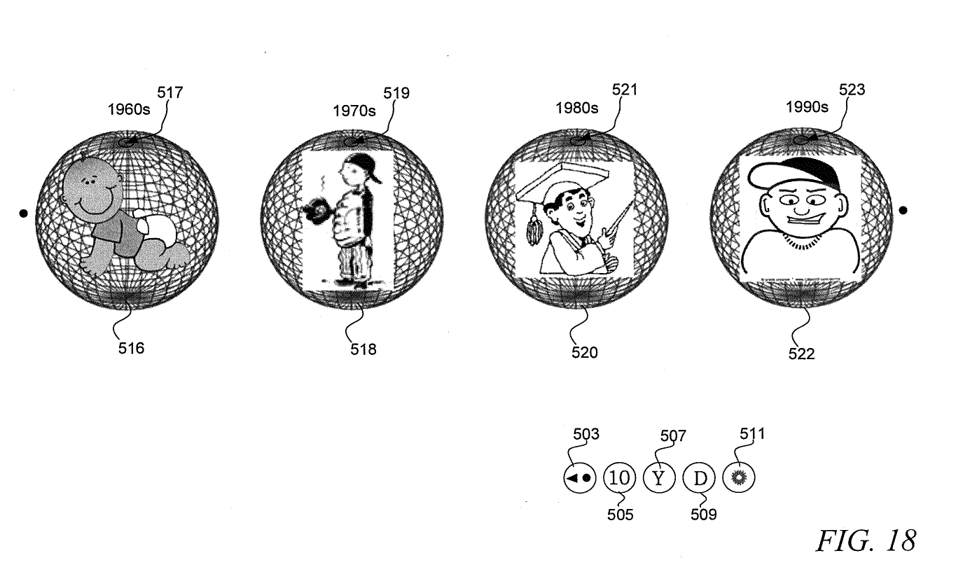

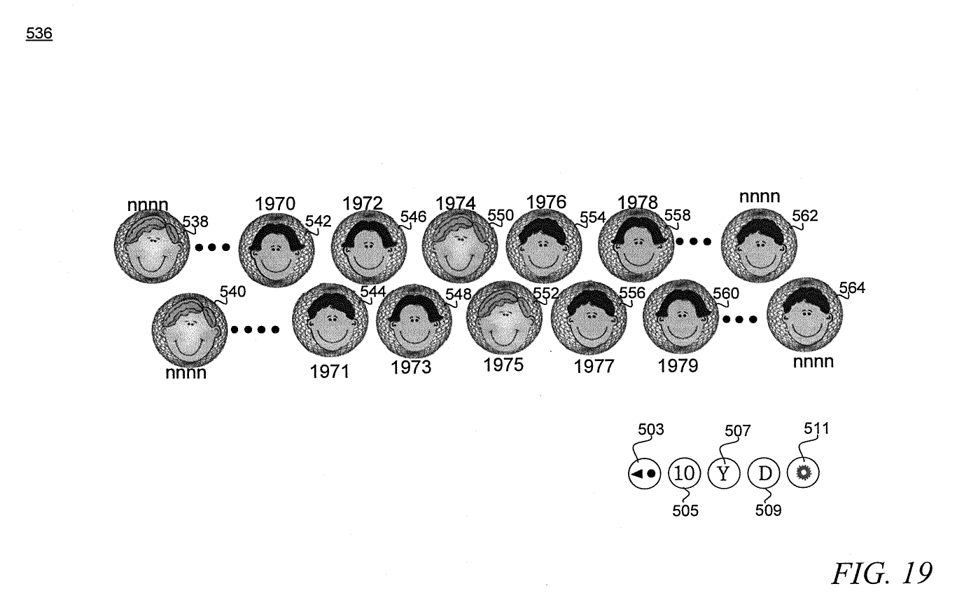

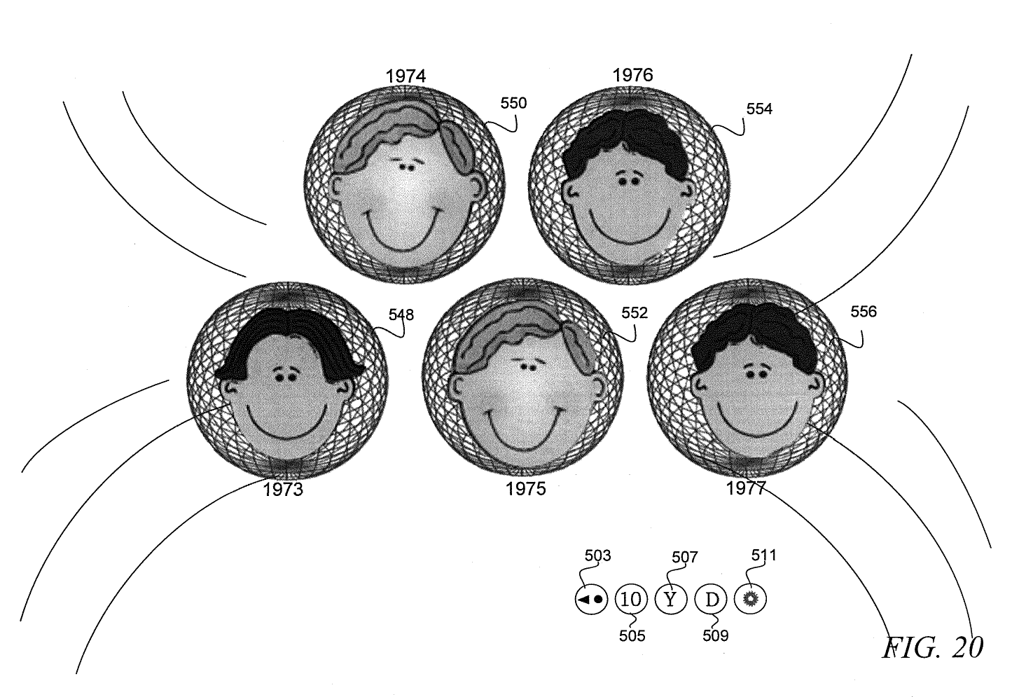

FIG. 17 is representative of the interior surface 504 of a the Jeffrey Morris Life Journal™, which includes an illustration of a plurality of sub-level viewable surfaces 512, 514, 516, 518, 520, 522, 524, 526, 528, in 530, each of which represents decades for which a representative Life Journal™ may have content. In the example illustrated in FIG. 17, content is available through viewable surfaces 516, 518, 520, 522, 524, and 526, wherein content availability is displayed and accessed in accordance with the time period of an associated respective decade. FIG. 17 displays content including Decaspheres representative of the 1960s, 1970s, 1980s, 1990s, 2000s, and 2010s decades displayed along a linear line wherein the beginning and ending of the representative decades within a respective viewable surface configured as a three-dimensional sphere are set by the input of parameters for a beginning decade 512 and an ending decade 530 that are input into the module. Access to the interior of content including Decaspheres 516, 518, 520, 522, 524, and 526, occurs by entering through entry portals 515, 517, 519, 521, 523, 525, 527, which causes the display of a point of view from within the interior of Decaspheres 516, 518, 520, 522, 524, and 526, such as that disclosed in FIGS. 19 and 20. FIG. 18 illustrates a zoomed view of FIG. 16 illustrating Decaspheres 516, 518, 520, 522 representative of four decades of content that comprise a period of time associated with the information being displayed within the Jeffrey Morris Life Journal™.

Referring to FIG. 19, FIG. 19 is representative of the interior surface of the Decasphere 518, illustrated in FIG. 18, which may be entered through entry portal 519. As illustrated, the interior surface 536 within Decasphere 518 representative of the 1970s decade, includes ten sub-level viewable surfaces configured as hollow three-dimensional spheres that each represents one of the ten years of the decade, Yearspheres. Yearsphere 542, representative of the year 1970, is configured as a three-dimensional sphere positioned along a central axis within the interior of Decasphere 536. Access to the interior of Yearsphere 150 occurs by entering through an entry portal (not shown), which causes the display of a point of view from within the interior of Yearsphere 542. Yearsphere 544, representative of the year 1971, is configured as a three-dimensional sphere positioned along a central axis within the interior of Decasphere 536. Access to the interior of Yearsphere 544, occurs by entering through an entry portal (not shown), which causes the display of a point of view from within the interior of Yearsphere 544. Yearsphere 546, representative of the year 1972, is configured as a three-dimensional sphere positioned along a central axis within the interior of Decasphere 536. Access to the interior of Yearsphere 546, occurs by entering through an entry portal (not shown), which causes the display of a point of view from within the interior of Yearsphere 546. Yearsphere 548, representative of the year 1973, is configured as a three-dimensional sphere positioned along a central axis along the interior surface of the interior of Decasphere 536. Access to the interior of Yearsphere 548, occurs by entering through an entry portal (not shown), which causes the display of a point of view from within the interior of Yearsphere 548. Yearsphere 550, representative of the year 1974, is configured as a three-dimensional sphere positioned along a central axis along the interior of Decasphere 536. Access to the interior of Yearsphere 550, occurs by entering through an entry portal (not shown), which causes the display of a point of view from within the interior of Yearsphere 550. Yearsphere 552, representative of the year 1975, is configured as a three-dimensional sphere positioned along a central axis along the interior of Decasphere 536. Access to the interior of Yearsphere 552, occurs by entering through an entry portal (not shown), which causes the display of a point of view from within the interior of Yearsphere 552. Yearsphere 554, representative of the year 1976, is configured as a three-dimensional sphere positioned along a central axis along the interior of Decasphere 536. Access to the interior of Yearsphere 554, occurs by entering through an entry portal (not shown), which causes the display of a point of view from within the interior of Yearsphere 554. Yearsphere 556, representative of the year 1977, is configured as a three-dimensional sphere positioned along a central axis along the interior of Decasphere 536. Access to the interior of Yearsphere 556, occurs by entering through an entry portal (not shown), which causes the display of a point of view from within the interior of Yearsphere 556. Yearsphere 558, representative of the year 1978, is configured as a three-dimensional sphere positioned along a central axis within the interior of Decasphere 536. Access to the interior of Yearsphere 558, occurs by entering through an entry portal (not shown), which causes the display of a point of view from within the interior of Yearsphere 558. Yearsphere 560, representative of the year 1979, is configured as a three-dimensional sphere positioned along a central axis within the interior of Decasphere 536. Access to the interior of Yearsphere 560, occurs by entering through an entry portal (not shown), which causes the display of a point of view from within the interior of Yearsphere 560.

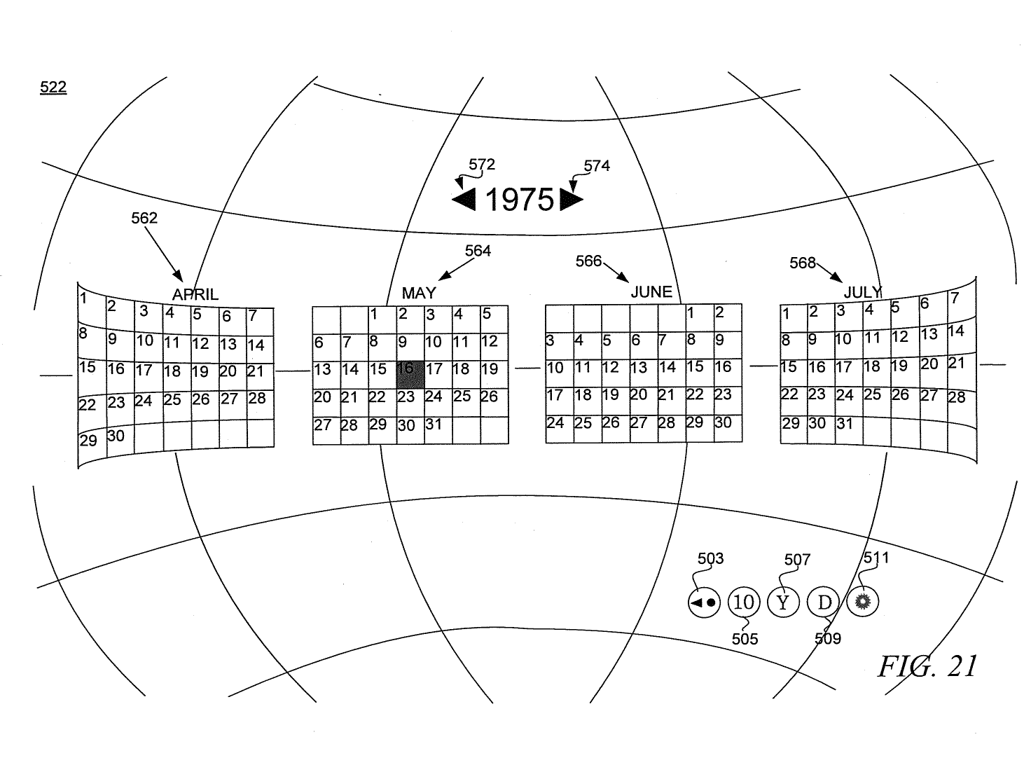

FIG. 20 is a zoomed in view of the interior surface of the Decasphere 518, illustrated in FIG. 18, illustrating Yearspheres 548, 550, 552, 554 and 556 for years 1973, 1974, 1975, 1976 and 1977. The module equips the interface within the interior of Decasphere 536, illustrated in FIGS. 19 and 20, with an interface, that facilitates movement between Centaspheres, Decaspheres, Yearspheres and Dayspheres, wherein upon selecting button 503 with a cursor, display control buttons 505, 507, 509 and 511 are displayed. Button 505 facilitates the display of Decaspheres within a Centasphere, similar to that illustrated in FIG. 504. Button 507 facilitates the display of Yearspheres within an interior surface of a Decasphere similar to that displayed in FIG. 18. Button 509 facilitates the display of Dayspheres or day surfaces within the interior surface of a Yearsphere such as that disclosed in FIG. 21.

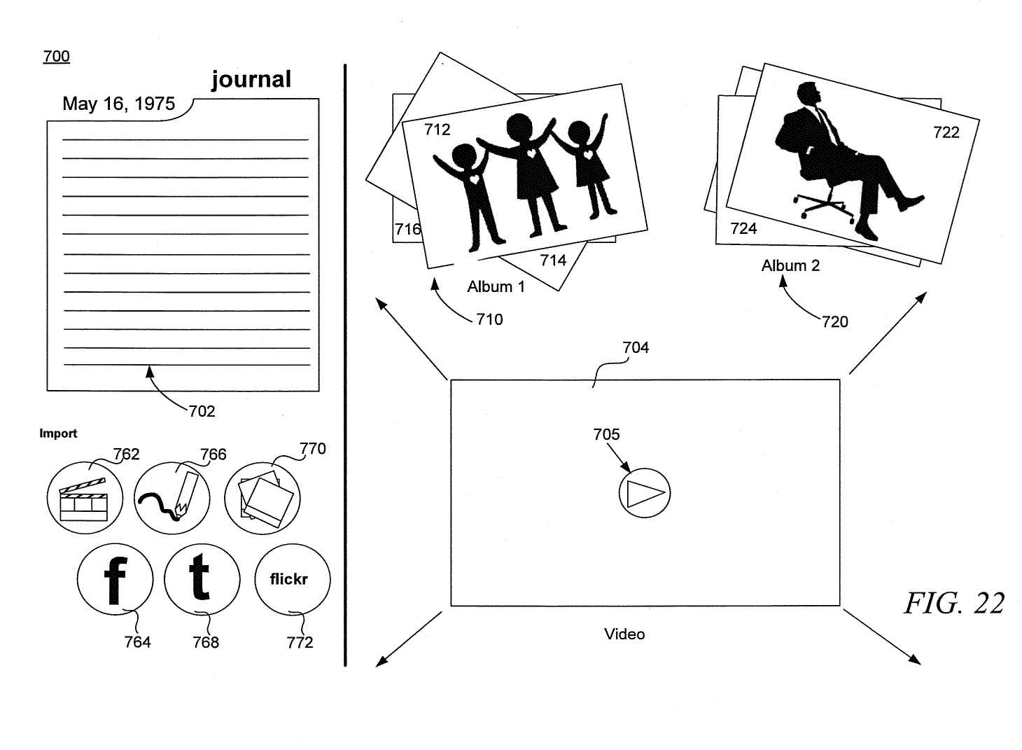

FIG. 21 is representative of the interior surface of Yearsphere 552 illustrated in FIGS. 19 and 20, representative of the year 1975, illustrating four sub-level viewable surfaces, which may be configured as surfaces within hollow three-dimensional spheres, Monthspheres, but are displayed a two-dimensional surfaces within Yearsphere 552 that each represents the months of April, May, June and July of the year 1975. It is contemplated that the year 1975, and all other respective monthly viewable surfaces proximate the monthly viewable surfaces illustrated for the months in 1975 are displayed along a scrollable linear line wherein the beginning and ending of the representative monthly viewable surfaces displayed within a three-dimensional sphere are set by the parameters input into the module. FIG. 21 represents a zoomed view within Yearsphere 552 representative of the year 1975 zooming in on the months of April, May, June and July. Two-dimensional display surface 562, representative of the month of April, is positioned along a central axis within the interior surface of the Yearsphere 552 representative of the year 1975. Similar to the month of April, two-dimensional display surfaces representative of the month of May 564, the month of June 456 and the month of July 568 are displayed along the central axis within the interior of Yearsphere 552. Each of the two dimensional monthly display surfaces illustrated includes interactive sub levels which may be accessed by selecting a specific day within a specific two-dimensional monthly display. For example, upon selection of 16 May within two-dimensional monthly display 564, the user is presented with a journal display screen 700, illustrated in FIG. 22, representative of the day, May 16, 1975 selected by the user.

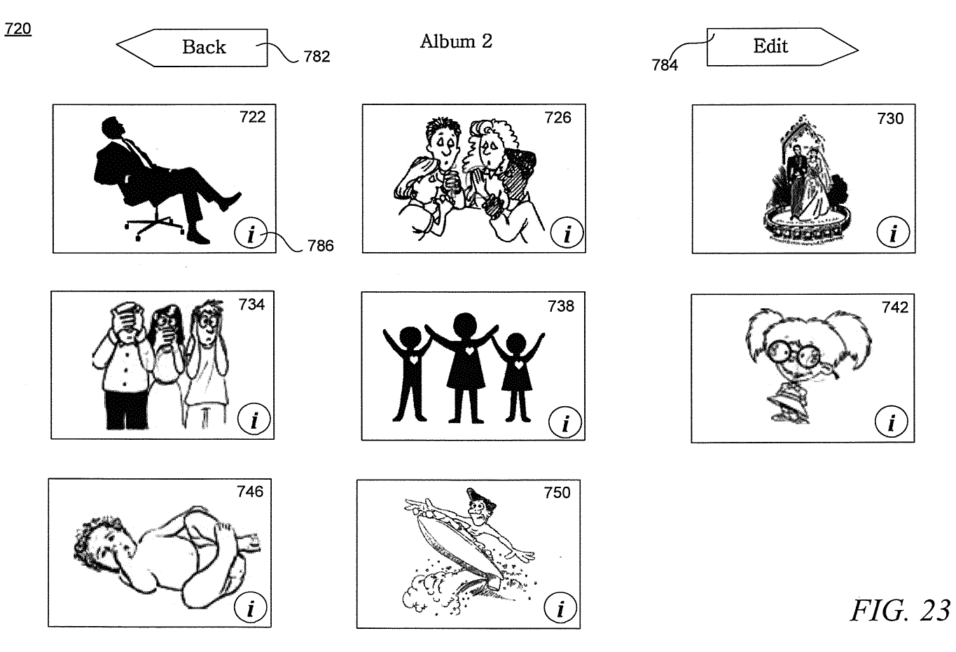

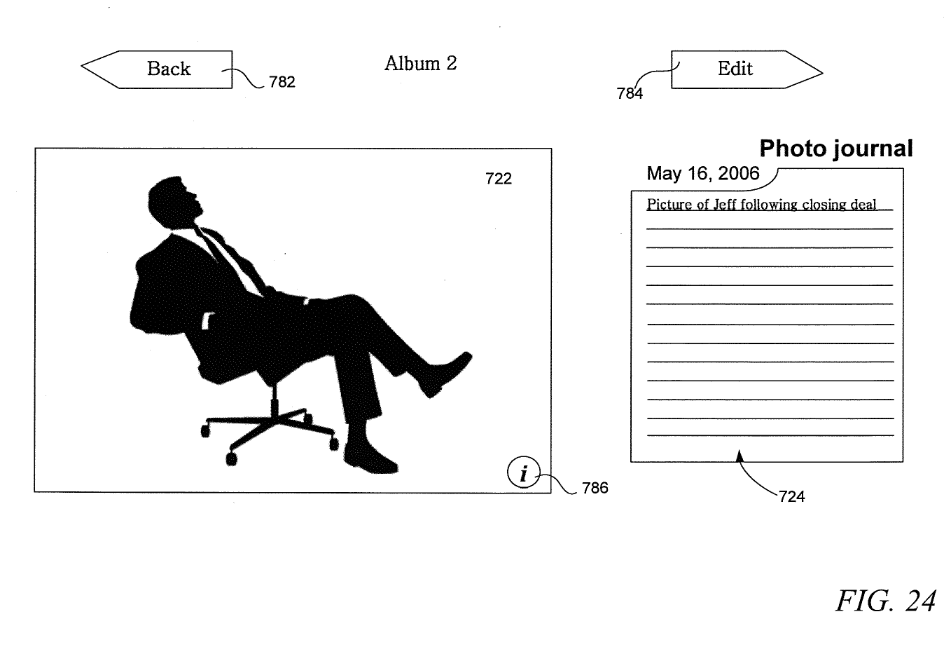

As illustrated in FIG. 22, Journal display screen 700 includes a journal display area 702 for the display and inclusion of notes regarding data associated with the respective day, of the present example, May 16, 1975. As illustrated, May 16, 1975, has two photo albums, 710, 720 and a video display cabinet 704, which may be entered upon selection of video display button 705. Photo album 720 may be accessed upon selecting the top photograph 722 within the photo album, causing a display of photo album 720 in an expanded form as illustrated in FIG. 23. As FIG. 23 illustrates, photo album 720 includes eight photos, 722, 726, 730, 734, 738, 742, 746, and 750. Photo album 720 is also equipped with control buttons 782 and 704 which facilitate movement back 782 from photo album 722 to the Journal display area 702 or the editing 784 of the photo album whereby photos may be added or removed. As illustrated in FIG. 24, each photo within a respective photo album includes an information button 786, which facilitates the opening of a journal notepad 724 upon which a user may record notes and memories regarding a respective photograph, recording specific events to provide context for a photograph.

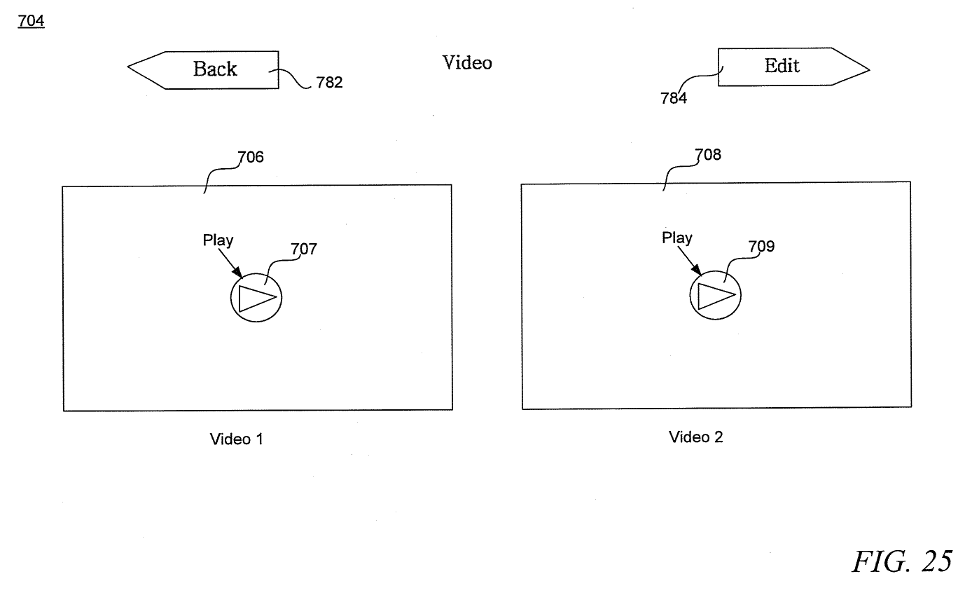

Referring back to FIG. 22, upon selection of the video display button 705 the user is directed to FIG. 25 which illustrates a catalog of videos 706 708 that a user may view upon selection of video display buttons 707 and 709. Referring back to FIG. 22, Journal display screen 700 also includes a plurality of import functions which allow for the importation of content from a plurality of sources directly into a respective Content Journal/LifeJournal™. Movie import display 762 allows for the importation of video content from a plurality of sources. Writing import display button 766 allows for the importation of documents from a plurality of sources. Picture import display button 770 allows for the importation of photographs from a plurality of sources such as, for example an iPAD photo gallery when the Content Journal/LifeJournal™ application is operating in an iPAD environment. Facebook import display 764 allows for the importation of video, pictures and other content from a user's respective Facebook page. Twitter import display 768 allows for the importation of video, pictures and other content from a user's respective Twitter page. Flickr import display 772 allows for the importation of video, pictures and other content from users with perspective Flickr page.

It is contemplated that the present invention shall be configured for integration and importation of additional information within social media platforms other than Facebook and Flickr. Accordingly, an embodiment of the invention may be equipped with additional social media platform import display modules in addition to the Facebook import display 764 and the Flickr import display 772 illustrated in FIG. 22, allowing for group creation of Content Journals populated by users having access and content population control rights within a respective Content Journal utilizing the three dimensional graphical user interface module. It is also contemplated that the three dimensional graphical user interface module may be used as a web browser, wherein information may be collected from a plurality of websites and data server platforms to which the present invention has been connected.

While certain features and embodiments of the invention have been described, other embodiments of the invention will be apparent to those skilled in the art from consideration of the specification and practice of the embodiments of the invention disclosed herein. Furthermore, although embodiments of the invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A computing system having a memory, a display, and software module residing in the memory, wherein the software module is operatively configured to generate a graphical user interface displaying information retrieved from a database storing a plurality of data files, the graphical user interface comprising:
a plurality of viewable surfaces, wherein at least one of the plurality of viewable surfaces is configured as a sphere and displayed three-dimensionally, wherein the at least one of the plurality of viewable surfaces configured as a sphere and displayed three-dimensionally includes a plurality of interface items displayed thereon;
wherein the user may access a second viewable surface configured as a three-dimensional sphere through at least one of an entrance point within a first viewable surface configured as a three-dimensional sphere and a plurality of interface items displayed on the first viewable surface, and
wherein the user may access data stored in the database upon selecting one of the plurality of interface items illustrated on the surface of one of the plurality of viewable surfaces.

2. The computing system of claim 1, wherein each viewable surface configured as a sphere is displayed as an interior three-dimensional surface perspective view and illustrated from a central point in the interior of the sphere.

3. The computing system of claim 1, wherein the viewable surfaces configured as a sphere is displayed as an exterior three-dimensional surface perspective view.

4. The computing system of claim 1, wherein selecting one of the plurality of objects illustrated on the surface of one of the plurality of viewable surfaces initiates retrieval of data stored in memory and presentation of the data retrieved on the display.

5. The computing system of claim 1, wherein the portion of the viewable surface illustrated on the display may be modified by moving a cursor within the three-dimensional sphere.

6. The computing system of claim 1, wherein a first viewable surface configured as a sphere and displayed as a three-dimensional image includes a graphical representation of a plurality of years extending along the circumference of the viewable surface, wherein selecting an object representative of a year transitions the user to a second viewable surface displayed as a three-dimensional image illustrating a graphical representation of twelve months of a year, wherein each month within the twelve months include a monthly viewable surface illustrating a graphical representation of a plurality of days, wherein each day of the plurality of days includes a graphical representation of a schedule having at least one time slot containing at least one descriptive entry.

7. The graphic user interface of claim 1 wherein each of the plurality of viewable surfaces each configured as a sphere and displayed as a three-dimensional image is configured to allow the user to transition between each sphere.

8. The computing system of claim 1, wherein a first viewable surface configured as a sphere and displayed as a three-dimensional perspective view is a main page of a web browser and includes a graphical representation of a plurality of interactive content buttons, allowing the user to transition between pages displayed as three-dimensional perspective views of associated content.

9. The graphic user interface of claim 1 wherein the central point in the interior of the sphere is at a center point along the x, y and z axis.

10. A computer readable storage medium, comprising one or more sequences of instructions, which when executed by one or more processors, cause the one or more processors to:
generate graphic user interface display windows on a computing system that display information retrieved from a database storing a plurality of data files, wherein the graphic user interface display windows illustrate:
a plurality of viewable surfaces, wherein at least one of the plurality of viewable surfaces is configured as a sphere and displayed three-dimensionally, wherein the at least one of the plurality of viewable surfaces configured as a sphere and displayed three-dimensionally includes a plurality of interface items displayed thereon;
wherein the user may access a second viewable surface configured as a three-dimensional sphere through at least one of an entrance point within a first viewable surface configured as a three-dimensional sphere and a plurality of interface items displayed on the first viewable surface, and
wherein the user may access data stored in the database upon selecting one of the plurality of interface items illustrated on the surface of one of the plurality of viewable surfaces.

11. A computer readable medium according to claim 10, wherein each viewable surface configured as a sphere is displayed as an interior three-dimensional surface perspective view and illustrated from a central point in the interior of the sphere.

12. A computer readable medium according to claim 10, wherein the viewable surfaces configured as a sphere is displayed as an exterior three-dimensional surface perspective view.

13. A computer readable medium according to claim 10, wherein selecting one of the plurality of objects illustrated on the surface of one of the plurality of viewable surfaces initiates retrieval of data stored in memory and presentation of the data retrieved on the display.

14. A computer readable medium according to claim 10, wherein the portion of the viewable surface illustrated on the display may be modified by moving a cursor within the three-dimensional sphere.

15. A computer readable medium according to claim 10, wherein a first viewable surface configured as a sphere and displayed as a three-dimensional image includes a graphical representation of a plurality of years extending along the circumference of the viewable surface, wherein selecting an object representative of a year transitions the user to a second viewable surface displayed as a three-dimensional image illustrating a graphical representation of twelve months of a year, wherein each month within the twelve months include a monthly viewable surface illustrating a graphical representation of a plurality of days, wherein each day of the plurality of days includes a graphical representation of a schedule having at least one time slot containing at least one descriptive entry.

16. A computer readable medium according to claim 10, wherein each of the plurality of viewable surfaces each configured as a sphere and displayed as a three-dimensional image is configured to allow the user to transition between each sphere.

17. A computer readable medium according to claim 10, wherein a first viewable surface configured as a sphere and displayed as a three-dimensional perspective view is a main page of a web browser and includes a graphical representation of a plurality of interactive content buttons, allowing the user to transition between pages displayed as three-dimensional perspective views of associated content.

18. A computer readable medium according to claim 10, wherein the central point in the interior of the sphere is at a center point along the x, y and z axis.
